(19) United States
(12) Patent Application Publication
(10) Pub. No.: US 2021/0249687 A1
(43) Pub. Date: Aug. 12, 2021

(54) POLYACRYLONITRILE GELS FOR ENERGY STORAGE

(71) Applicants: QUANTUMSCAPE CORPORATION, San Jose, CA (US); KYOTO UNIVERSITY, Kyoto-Shi, Kyoto (JP)

(72) Inventors: Mohit SINGH, Santa Clara, CA (US); Will HUDSON, Belmont, CA (US); Shigeru YAMAGO, Kyoto (JP)

(21) Appl. No.: 17/050,819

(22) PCT Filed: Apr. 30, 2019
(86) PCT No.: PCT/US2019/030038

§ 371 Date: Oct. 26, 2020

Related U.S. Application Data
(60) Provisional application No. 62/665,414, filed on May 1, 2018.

(51) Int. Cl. H01M 10/0565; H01M 10/052; H01M 4/134; H01M 4/38; H01M 50/434; H01M 10/44; C08F 220/48

(52) U.S. Cl. CPC H01M 10/0565; H01M 10/052; H01M 4/134; H01M 4/382; H01M 2004/027; H01M 10/44; C08F 220/48; H01M 2300/0085; H01M 2300/0082; H01M 50/434

(57) ABSTRACT

Provided herein are rechargeable battery (e.g., Li-ion and Li-metal anode) catholytes and electrolyte separators that include a chemically cross-linked polymer and a solvent selected from the group consisting of a nitrile, a dinitrile, or a combination thereof; processes for making and using the same; and rechargeable batteries and electrochemical cells that include high voltage stable catholytes and/or electrolyte separators.

### CROSS-REFERENCE TO RELATED APPLICATIONS

This applications claims the benefit of priority to U.S. Provisional Patent Application No. 62/665,414, filed May 1, 2018, the entire contents of which are herein incorporated by reference in its entirety for all purposes.

### FIELD

The present disclosure sets forth compositions comprising chemically cross-linked polymers. These chemically cross-linked polymers may include cyano (—CN) functional groups and are formulated with a nitrile solvent, a dinitrile solvent, or both. These chemically cross-linked polymers may tolerate high voltage conditions without reacting in a detrimental manner. The chemically cross-linked polymers set forth herein may be characterized as having a wide electrochemical stability window (ESW) and may be useful as rechargeable battery electrolyte separators. Also set forth herein are methods of making and using these electrolyte separators in electrochemical cells and energy storage devices.

### BACKGROUND

Previous researchers have prepared high voltage electrochemical batteries that include poly(acrylonitrile) (PAN) polymer electrolyte separators. However, these electrolyte separators were made by physical cross-linking reactions (see, e.g., Sekhon, S. S.; Arora, N.; Agnihotry, S. A. Solid State Ionics 2000, 136-137, 2101). Physical cross-linking can be defined as physical entanglement of separate polymer strands but without forming chemical bonds between the entangled polymer strands. For example, physical cross-linking may include spraying a solution of polymers onto a substrate and then drying the solution to form an entangled mat. Physical cross-linking reactions result in non-uniform polymers with stochastic properties, e.g., inhomogeneous structures, which vary with respect to molecular weight, amount, type, length, and uniformity of cross-linking.

Accordingly, there exists a need for improved polymer electrolyte separators for electrochemical batteries. Set forth herein are such improved polymers as well as other solutions to problems in the relevant field.

### SUMMARY

In one embodiment, set forth herein is a composition including a chemically cross-linked aprotic polymer comprising cyano (—CN) functional groups and a solvent selected from the group consisting of a nitrile, a dinitrile, and a combination thereof. In some embodiments, set forth herein is a composition including a chemically cross-linked polymer comprising at least one cyano (—CN) functional group and a solvent selected from the group consisting of a nitrile, a dinitrile, and a combination thereof.

In a second embodiment, set forth herein is a process for making a composition, including:
step 1: copolymerizing an acrylonitrile (AN) monomer and a methacrylamide monomer to form a polymer, wherein the methacrylamide monomer comprises amide functional groups; and
step 2: chemically cross-linking the polymer using a bifunctional cross-linker to form a cross-linked polymer.

In a third embodiment, set forth herein is a composition made by any one of the processes disclosed herein.

In a fourth embodiment, set forth herein is an electrochemical cell including a lithium metal negative electrode, a solid separator, and a positive electrode; wherein the positive electrode comprises an active material and a catholyte; wherein the catholyte comprises a chemically cross-linked polymer set forth herein; and a lithium salt.

In a fifth embodiment, set forth herein is an electrochemical cell including a lithium metal negative electrode, a solid separator, a positive electrode, and a bonding layer disposed between the solid separator and the positive electrode; wherein the positive electrode comprises an active material and a catholyte; and wherein the bonding layer comprises a chemically cross-linked polymer set forth herein; and a lithium salt.

In a sixth embodiment, set forth herein is a method of using an electrochemical cell set forth herein.

In a seventh embodiment, set forth herein is a method of storing an electrochemical cell, including:
providing an electrochemical cell of any one of those set forth herein; wherein the electrochemical cell has greater than 20% state-of-charge (SOC); and
storing the battery for at least one day.

In an eighth embodiment, set forth herein is a method of storing an electrochemical cell, including:
providing an electrochemical cell of any one of those set forth herein; wherein the electrochemical cell has a voltage v. Li greater than 4.2 V; and
storing the battery for at least one day.

### BRIEF DESCRIPTIONS OF THE DRAWINGS

FIGS. 1a-1c show the effect of time on the monomer conversion for the polymerization shown in Table 1, run 1. FIG. 1a shows molecular weight as a function of percent conversion. FIG. 1b shows Mₙ and Ð vs. the monomer conversion. FIG. 1c shows SEC traces at different times.

FIGS. 2a-2b show fabrication of PAN-based gel swollen in adiponitrile. FIG. 2a shows SEC traces at different times and FIG. 2b shows photographs of polymer gels.

FIGS. 3a, 3b, and 3c show frequency dependence of storage modulus (FIG. 3a), loss modulus (FIG. 3b), and phase angle (FIG. 3c).

FIG. 4 shows ¹H NMR spectrum of 6F.

### DETAILED DESCRIPTION

### A. Definitions

As used herein, the term “about,” when qualifying a number, e.g., about 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein, the phrase “Li⁺ ion-conducting separator” refers to an electrolyte which conducts Li⁺ ions, is substantially insulating to electrons (e.g., the lithium ion conductivity is at least 10³ times, and often 10⁶ times, greater than the electron conductivity), and which acts as a physical barrier or spacer between the positive and negative electrodes in an electrochemical cell.

As used herein, the phrases “solid separator,” “solid electrolyte,” “solid-state separator,” and “solid-state electrolyte” refer to Li⁺ ion-conducting separators that are solids at room temperature and include at least 50 vol % ceramic material.

As used herein, the phrase “electrochemical cell” refers to, for example, a “battery cell” and includes a positive electrode, a negative electrode, and an electrolyte therebetween which conducts ions (e.g., Li⁺) but electrically insulates the positive and negative electrodes. In some embodiments, a battery may include multiple positive electrodes and/or multiple negative electrodes enclosed in one container.

As used herein the phrase “electrochemical stack” refers to one or more units which each include at least a negative electrode (e.g., Li, LiC₆), a positive electrode (e.g., Li-nickel-manganese-oxide or FeF₃, optionally combined with a solid-state electrolyte or a gel electrolyte), and a solid electrolyte (e.g., an oxide electrolyte set forth herein, a lithium-stuffed garnet film, or a lithium-stuffed garnet pellet) between and in contact with the positive and negative electrodes. In some examples, between the solid electrolyte and the positive electrode, there is an additional layer including a compliant (e.g., gel electrolyte). An electrochemical stack may include one of these aforementioned units. An electrochemical stack may include several of these aforementioned units arranged in electrical communication (e.g., serial or parallel electrical connection). In some examples, when the electrochemical stack includes several units, the units are layered or laminated together in a column. In some examples, when the electrochemical stack includes several units, the units are layered or laminated together in an array. In some examples, when the electrochemical stack includes several units, the stacks are arranged such that one negative electrode is shared with two or more positive electrodes. Alternatively, in some examples, when the electrochemical stack includes several units, the stacks are arranged such that one positive electrode is shared with two or more negative electrodes. Unless specified otherwise, an electrochemical stack includes one positive electrode, one solid electrolyte, and one negative electrode, and optionally includes a gel electrolyte layer between the positive electrode and the solid electrolyte. In some examples, the gel electrolyte layer is also included in the positive electrode. In some examples, the gel electrolyte includes any electrolyte set forth herein, including a nitrile, dinitrile, organic sulfur-including solvent, or combination thereof set forth herein.

As used herein, the term “electrolyte” refers to a material that allows ions, e.g., Li⁺, to migrate or conduct therethrough but which does not allow electrons to conduct therethrough. Electrolytes are useful for electrically isolating the cathode and anodes of a secondary battery while allowing ions, e.g., Li⁺, to transmit through the electrolyte. Solid electrolytes, in particular, rely on ion hopping through rigid structures. Solid electrolytes may be also referred to as fast ion conductors or super-ionic conductors. Solid electrolytes may be also used for electrically insulating the positive and negative electrodes of a cell while allowing for the conduction of ions, e.g., Li⁺, through the electrolyte. In this case, a solid electrolyte layer may be also referred to as a solid electrolyte separator or solid-state electrolyte separator.

As used herein, the phrases “gel electrolyte” unless specified otherwise, refers to a suitable Li⁺ ion conducting gel or liquid-based electrolyte, for example but not limited to, those set forth in U.S. Pat. No. 5,296,318, entitled RECHARGEABLE LITHIUM INTERCALATION BATTERY WITH HYBRID POLYMERIC ELECTROLYTE or US Patent Application Publication No. US20170331092A1, entitled SOLID ELECTROLYTE SEPARATOR BONDING AGENT.

A gel electrolyte has a lithium ion conductivity of greater than 10⁻⁵ S/cm at room temperature, a lithium transference number between 0.05-0.95, and a storage modulus greater than the loss modulus at some temperature. A gel electrolyte may comprise a polymer matrix, a solvent that gels the polymer, and a lithium containing salt that is at least partly dissociated into Li⁺ ions and anions. Alternately, a gel electrolyte may comprise a porous polymer matrix, a solvent that fills the pores, and a lithium containing salt that is at least partly dissociated into Li⁺ ions and anions where the pores have one length scale less than 10 μm.

As used herein, the phrase “directly contacts” refers to the juxtaposition of two materials such that the two materials contact each other sufficiently to conduct either an ion or electron current. As used herein, direct contact refers to two materials in contact with each other and which do not have any materials positioned between the two materials which are in direct contact.

As used herein, the terms “cathode” and “anode” refer to the electrodes of a battery. The cathode and anode are often referred to in the relevant field as the positive electrode and negative electrode, respectively. During a charge cycle in a Li-secondary battery, Li ions leave the cathode and move through an electrolyte, to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode.

As used herein, the phrase “positive electrode” refers to the electrode in a secondary battery towards which positive ions, e.g., Li⁺, conduct, flow or move during discharge of the battery. As used herein, the phrase “negative electrode” refers to the electrode in a secondary battery from where positive ions, e.g., Li⁺, flow or move during discharge of the battery. In a battery comprised of a Li-metal electrode and a conversion chemistry, intercalation chemistry, or combination conversion/intercalation chemistry-including electrode (i.e., cathode active material; e.g., NiFₓ, NCA, LiNiₓMn_{y}Co_{z}O₂ [NMC] or LiNiₓAl_{y}Co_{z}O₂ [NCA], wherein x+y+z=1), the electrode having the conversion chemistry, intercalation chemistry, or combination conversion/intercalation chemistry material is referred to as the positive electrode. In some usages, cathode is used in place of positive electrode, and anode is used in place of negative electrode. When a Li-secondary battery is charged, Li ions move from the positive electrode (e.g., NiFₓ, NMC, NCA) towards the negative electrode (e.g., Li-metal). When a Li-secondary battery is discharged, Li ions move towards the positive electrode and from the negative electrode.

As used herein, the term “catholyte” refers to a Li ion conductor that is intimately mixed with, or that surrounds and contacts, or that contacts the positive electrode active materials and provides an ionic pathway for Li⁺ to and from the active materials. Catholytes suitable with the embodiments described herein include, but are not limited to, catholytes having the acronyms name LPS, LXPS, LXPSO, where X is Si, Ge, Sn, As, Al, LATS, or also Li-stuffed garnets, or combinations thereof, and the like. Catholytes may also be liquid, gel, semi-liquid, semi-solid, polymer, and/or solid polymer ion conductors. In some examples, the catholyte includes a gel set forth herein. In some examples, the gel electrolyte includes any electrolyte set forth herein, including a nitrile, dinitrile, organic sulfur-including solvent, or combination thereof set forth herein.

In some examples, the electrolytes herein may include, or be layered with, or be laminated to, or contact a sulfide electrolyte. As used here, the phrase “sulfide electrolyte,” includes, but is not limited to, electrolytes referred to herein as LSS, LTS, LXPS, or LXPSO, where X is Si, Ge, Sn, As, Al, LATS. In these acronyms (LSS, LTS, LXPS, or LXPSO), S refers to the element sulfur (S), silicon (Si), or combinations thereof, and T refers to the element Sn. “Sulfide electrolyte” may also include LiₐP_{b}S_{C}X_{d}, LiₐB_{b}S_{C}X_{d}, LiₐSn_{b}S_{C}X_{d} or LiₐSi_{b}S_{C}X_{d} where X=F, Cl, Br, I, and 10%≤a≤50%, 10%≤b≤44%, 24%≤c≤70%, 0≤d≤18% and may further include oxygen in small amounts. For example, oxygen may be present as a dopant or in an amount less than 10 percent by weight. For example, oxygen may be present as a dopant or in an amount less than 5 percent by weight.

As used here, the phrases “sulfide electrolyte” and “sulfide based electrolytes” include, but are not limited to, LSS, LTS, LXPS, LXPSO, where X is Si, Ge, Sn, As, Al, LATS, or combinations thereof. S is S, Si, or combinations thereof, and T is Sn. Also included are electrolytes that include inorganic materials containing S which conduct ions (e.g., Li⁺) and which are suitable for electrically insulating the positive and negative electrodes of an electrochemical cell (e.g., secondary battery). Exemplary sulfide based electrolytes include, but are not limited to, those electrolytes set forth in International Patent Application PCT Patent Application No. PCT/US14/38283, SOLID STATE CATHOLYTE OR ELECTROLYTE FOR BATTERY USING Li_{A}MP_{B}S_{C} (M=SI, GE, AND/OR SN), filed May 15, 2014, and published as WO 2014/186634, on Nov. 20, 2014, which is incorporated by reference herein in its entirety; also, U.S. Pat. No. 8,697,292 to Kanno, et al, the contents of which are incorporated by reference in their entirety.

As used herein, “SLOPS” includes, unless otherwise specified, a 60:40 molar ratio of Li₂S:SiS₂ with 0.1-10 mol. % Li₃PO₄. In some examples, “SLOPS” includes Li₁₀Si₄S₁₃ (50:50 Li₂S:SiS₂) with 0.1-10 mol. % Li₃PO₄. In some examples, “SLOPS” includes Li₂₆Si₇S₂₇ (65:35 Li₂S:SiS₂) with 0.1-10 mol. % Li₃PO₄. In some examples, “SLOPS” includes Li₄SiS₄ (67:33 Li₂S:SiS₂) with 0.1-5 mol. % Li₃PO₄. In some examples, “SLOPS” includes Li₁₄Si₃S₁₃ (70:30 Li₂S:SiS₂) with 0.1-5 mol. % Li₃PO₄. In some examples, “SLOPS” is characterized by the formula (1-x)(60:40 Li₂S:SiS₂)*(x)(Li₃PO₄), wherein x is from 0.01 to 0.99. As used herein, “LBS-POX” refers to an electrolyte composition of Li₂S:B₂S₃:Li₃PO₄:LiX where X is a halogen (X=F, Cl, Br, I). The composition can include Li₃BS₃ or Li₅B₇S₁₃ doped with 0-30% lithium halide such as LiI and/or 0-10% Li₃PO₄.

As used here, “LBS” refers to an electrolyte material characterized by the formula LiₐB_{b}S_{C} and may include oxygen and/or a lithium halide (LiF, LiCl, LiBr, LiI) at 0-40 mol %.

As used here, “LPSO” refers to an electrolyte material characterized by the formula LiₓP_{y}S_{z}O_{w} where 0.33≤x≤0.67, 0.07≤y≤0.2, 0.4≤z≤0.55, 0≤w≤0.15. Also, LPSO refers to LPS, as defined above, that includes an oxygen content of from 0.01 to 10 atomic %.

In some examples, the oxygen content is 1 atomic %. In other examples, the oxygen content is 2 atomic %. In some other examples, the oxygen content is 3 atomic %. In some examples, the oxygen content is 4 atomic %. In other examples, the oxygen content is 5 atomic %. In some other examples, the oxygen content is 6 atomic %. In some examples, the oxygen content is 7 atomic %. In other examples, the oxygen content is 8 atomic %. In some other examples, the oxygen content is 9 atomic %. In some examples, the oxygen content is 10 atomic %.

As used herein, the term “LBHI” or “LiBHI” refers to a lithium conducting electrolyte comprising Li, B, H, and I. More generally, it is understood to include aLiBH₄+bLiX where X=Cl, Br, and/or I and where a:b=7:l, 6:1, 5:1, 4:1, 3:1, 2:1, or within the range a/b=2-4. LBHI may further include nitrogen in the form of aLiBH₄+bLiX+cLiNH₂ where (a+c)/b=2-4 and c/a=0-10.

As used herein, the term “LPSI” refers to a lithium conducting electrolyte comprising Li, P, S, and I. More generally, it is understood to include aLi₂S+bP₂S_{y}+cLiX where X=Cl, Br, and/or I and where y=3-5 and where a/b=2.5-4.5 and where (a+b)/c=0.5-15.

As used herein, the term “LIRAP” refers to a lithium rich antiperovskite and is used synonymously with “LOC” or “Li₃OCl”. The composition of LIRAP is aLi₂O+bLiX+cLiOH+dAl₂O₃ where X=Cl, Br, and/or I, a/b=0.7-9, c/a=0.01-1, d/a=0.001-0.1.

As used herein, “LSS” refers to lithium silicon sulfide which can be described as Li₂S—SiS₂, Li—SiS₂, Li—S—Si, and/or a catholyte consisting essentially of Li, S, and Si. LSS refers to an electrolyte material characterized by the formula LiₓSi_{y}S_{z} where 0.33≤x≤0.5, 0.1≤y≤0.2, 0.4≤z≤0.55, and it may include up to 10 atomic % oxygen. LSS also refers to an electrolyte material comprising Li, Si, and S. In some examples, LSS is a mixture of Li₂S and SiS₂. In some examples, the ratio of Li₂S:SiS₂ is 90:10, 85:15, 80:20, 75:25, 70:30, 2:1, 65:35, 60:40, 55:45, or 50:50 molar ratio. LSS may be doped with compounds such as LiₓPO_{y}, LiₓBO_{y}, Li₄SiO₄, Li₃MO₄, Li₃MO₃, PSₓ, and/or lithium halides such as, but not limited to, LiI, LiCl, LiF, or LiBr, wherein 0≤x≤5 and 0≤y≤5.

As used herein, “LTS” refers to a lithium tin sulfide compound which can be described as Li₂S—SnS₂, Li₂S—SnS, Li—S—Sn, and/or a catholyte consisting essentially of Li, S, and Sn. The composition may be LiₓSn_{y}S_{z} where 0.25≤x≤0.65, 0.05≤y≤0.2, and 0.25≤z≤0.65. In some examples, LTS is a mixture of Li₂S and SnS₂ in the ratio of 80:20, 75:25, 70:30, 2:1, or 1:1 molar ratio. LTS may include up to 10 atomic % oxygen. LTS may be doped with Bi, Sb, As, P, B, Al, Ge, Ga, and/or In. As used herein, “LATS” refers to LTS, as used above, and further comprising Arsenic (As).

As used herein, “LXPS” refers to a material characterized by the formula LiₐMP_{b}S_{C}, where M is Si, Ge, Sn, and/or Al, and where 2≤a≤8, 0.5≤b≤2.5, 4≤c≤12. “LSPS” refers to an electrolyte material characterized by the formula LₐSiP_{b}S_{C}, where 2≤a≤8, 0.5≤b≤2.5, 4≤c≤12. LSPS refers to an electrolyte material characterized by the formula LₐSiP_{b}S_{C}, wherein, where 2≤a≤8, 0.5≤b≤2.5, 4≤c≤12, d<3. Exemplary LXPS materials are found, for example, in International Patent Application No. PCT/US14/38283, SOLID STATE CATHOLYTE OR ELECTROLYTE FOR BATTERY USING Li_{A}MP_{B}S_{C} (M=SI, GE, AND/OR SN), filed May 15, 2014, and published as WO 2014/186634, on Nov. 20, 2014, which is incorporated by reference herein in its entirety. Exemplary LXPS materials are found, for example, in U.S. patent application Ser. No. 14/618,979, filed Feb. 10, 2015, and published as Patent Application Publication No. 2015/0171465, on Jun. 18, 2015, which is incorporated by reference herein in its entirety. When M is Sn and Si—both are present—the LXPS material is referred to as LSTPS. As used herein, “LSTPSO” refers to LSTPS that is doped with, or has, O present. In some examples, “LSTPSO” is a LSTPS material with an oxygen content between 0.01 and 10 atomic %. “LSPS” refers to an electrolyte material having Li, Si, P, and S chemical constituents. As used herein “LSTPS” refers to an electrolyte material having Li, Si, P, Sn, and S chemical constituents. As used herein, “LSPSO” refers to LSPS that is doped with, or has, O present. In some examples, “LSPSO” is a LSPS material with an oxygen content between 0.01 and 10 atomic %. As used herein, “LATP,” refers to an electrolyte material having Li, As, Sn, and P chemical constituents. As used herein “LAGP” refers to an electrolyte material having Li, As, Ge, and P chemical constituents. As used herein, “LXPSO” refers to a catholyte material characterized by the formula LiₐMP_{b}S_{c}O_{d}, where M is Si, Ge, Sn, and/or Al, and where 2≤a≤8, 0.5≤b≤2.5, 4≤c≤12, d≤3. LXPSO refers to LXPS, as defined above, and having oxygen doping at from 0.1 to about 10 atomic %. LPSO refers to LPS, as defined above, and having oxygen doping at from 0.1 to about 10 atomic %.

As used herein, “LPS” refers to an electrolyte having Li, P, and S chemical constituents. As used herein, “LPSO” refers to LPS that is doped with or has O present. In some examples, “LPSO” is a LPS material with an oxygen content between 0.01 and 10 atomic %. LPS refers to an electrolyte material that can be characterized by the formula LiₓP_{y}S_{z} where 0.33≤x≤0.67, 0.07≤y≤0.2 and 0.4≤z≤0.55. LPS also refers to an electrolyte characterized by a product formed from a mixture of Li₂S:P₂S₅ wherein the molar ratio is 10:1, 9:1, 8:1, 7:1, 6:1 5:1, 4:1, 3:1, 7:3, 2:1, or 1:1. LPS also refers to an electrolyte characterized by a product formed from a mixture of Li₂S:P₂S₅ wherein the reactant or precursor amount of Li₂S is 95 atomic % and P₂S₅ is 5 atomic %. LPS also refers to an electrolyte characterized by a product formed from a mixture of Li₂S:P₂S₅ wherein the reactant or precursor amount of Li₂S is 90 atomic % and P₂S₅ is 10 atomic %. LPS also refers to an electrolyte characterized by a product formed from a mixture of Li₂S:P₂S₅ wherein the reactant or precursor amount of Li₂S is 85 atomic % and P₂S₅ is 15 atomic %. LPS also refers to an electrolyte characterized by a product formed from a mixture of Li₂S:P₂S₅ wherein the reactant or precursor amount of Li₂S is 80 atomic % and P₂S₅ is 20 atomic %. LPS also refers to an electrolyte characterized by a product formed from a mixture of Li₂S:P₂S₅ wherein the reactant or precursor amount of Li₂S is 75 atomic % and P₂S₅ is 25 atomic %. LPS also refers to an electrolyte characterized by a product formed from a mixture of Li₂S:P₂S₅ wherein the reactant or precursor amount of Li₂S is 70 atomic % and P₂S₅ is 30 atomic %. LPS also refers to an electrolyte characterized by a product formed from a mixture of Li₂S:P₂S₅ wherein the reactant or precursor amount of Li₂S is 65 atomic % and P₂S₅ is 35 atomic %. LPS also refers to an electrolyte characterized by a product formed from a mixture of Li₂S:P₂S₅ wherein the reactant or precursor amount of Li₂S is 60 atomic % and P₂S₅ is 40 atomic %.

As used herein, the term “rational number” refers to any number which can be expressed as the quotient or fraction (e.g., p/q) of two integers (e.g., p and q), with the denominator (e.g., q) not equal to zero. Example rational numbers include, but are not limited to, 1, 1.1, 1.52, 2, 2.5, 3, 3.12, and 7.

As used herein, the phrase “lithium stuffed garnet” refers to oxides that are characterized by a crystal structure related to a garnet crystal structure. U.S. Patent Application Publication No. U.S. 2015/0099190, which published Apr. 9, 2015 and was filed Oct. 7, 2014 as Ser. No. 14/509,029, is incorporated by reference herein in its entirety. This application describes Li-stuffed garnet solid-state electrolytes used in solid-state lithium rechargeable batteries. These Li-stuffed garnets include compositions according to Li_{A}La_{B}M′_{C}M″_{D}Zr_{E}O_{F}, Li_{A}La_{B}M′_{C}M″_{D}Ta_{E}O_{F}, or Li_{A}La_{B}M′_{C}M″_{D}Nb_{E}O_{F}, wherein 4<A<8.5, 1.5<B<4, 0≤C≤2, 0≤D≤2; 0≤E≤2.5, 10≤F≤13, and M′ and M″ are each, independently in each instance selected from Ga, Al, Mo, W, Nb, Sb, Ca, Ba, Sr, Ce, Hf, Rb, and Ta, or LiₐLa_{b}Zr_{c}Al_{d}Me″ₑO_{f}, wherein 5<a<8.5; 2<b<4; 0<c≤2.5; 0≤d<2; 0≤e<2, and 10<f<13 and Me″ is a metal selected from Ga, Nb, Ta, V, W, Mo, and Sb and as otherwise described in U.S. Patent Application Publication No. U.S. 2015/0099190. As used herein, lithium-stuffed garnets, and garnets, generally, include, but are not limited to, Li_{7.0}La₃(Zrₜ₁+Nbₜ₂+Taₜ₃)O₁₂++0.35Al₂O₃; wherein (t1+t2+t3=2) so that the La:(Zr/Nb/Ta) ratio is 3:2. Also, garnets used herein include, but are not limited to, LiₓLa₃Zr₂O_{F}+yAl₂O₃, wherein x ranges from 5.5 to 9; and y ranges from 0.05 to 1. In these examples, subscripts x, y, and F are selected so that the garnet is charge neutral. In some examples x is 7 and y is 1.0. In some examples, x is 5 and y is 1.0. In some examples, x is 6 and y is 1.0. In some examples, x is 8 and y is 1.0. In some examples, x is 9 and y is 1.0. In some examples x is 7 and y is 0.35. In some examples, x is 5 and y is 0.35. In some examples, x is 6 and y is 0.35. In some examples, x is 8 and y is 0.35. In some examples, x is 9 and y is 0.35. In some examples x is 7 and y is 0.7. In some examples, x is 5 and y is 0.7. In some examples, x is 6 and y is 0.7. In some examples, x is 8 and y is 0.7. In some examples, x is 9 and y is 0.7. In some examples x is 7 and y is 0.75. In some examples, x is 5 and y is 0.75. In some examples, x is 6 and y is 0.75. In some examples, x is 8 and y is 0.75. In some examples, x is 9 and y is 0.75. In some examples x is 7 and y is 0.8. In some examples, x is 5 and y is 0.8. In some examples, x is 6 and y is 0.8. In some examples, x is 8 and y is 0.8. In some examples, x is 9 and y is 0.8. In some examples x is 7 and y is 0.5. In some examples, x is 5 and y is 0.5. In some examples, x is 6 and y is 0.5. In some examples, x is 8 and y is 0.5. In some examples, x is 9 and y is 0.5. In some examples x is 7 and y is 0.4. In some examples, x is 5 and y is 0.4. In some examples, x is 6 and y is 0.4. In some examples, x is 8 and y is 0.4. In some examples, x is 9 and y is 0.4. In some examples x is 7 and y is 0.3. In some examples, x is 5 and y is 0.3. In some examples, x is 6 and y is 0.3. In some examples, x is 8 and y is 0.3. In some examples, x is 9 and y is 0.3. In some examples x is 7 and y is 0.22. In some examples, x is 5 and y is 0.22. In some examples, x is 6 and y is 0.22. In some examples, x is 8 and y is 0.22. In some examples, x is 9 and y is 0.22. Also, garnets as used herein include, but are not limited to, LiₓLa₃Zr₂O₁₂+yAl₂O₃. In one embodiment, the Li-stuffed garnet herein has a composition of Li₇Li₃Zr₂O₁₂. In another embodiment, the Li-stuffed garnet herein has a composition of Li₇Li₃Zr₂O₁₂.Al₂O₃. In yet another embodiment, the Li-stuffed garnet herein has a composition of Li₇Li₃Zr₂O₁₂.0.22Al₂O₃. In yet another embodiment, the Li-stuffed garnet herein has a composition of Li₇Li₃Zr₂O₁₂.0.35Al₂O₃. In certain other embodiments, the Li-stuffed garnet herein has a composition of Li₇Li₃Zr₂O₁₂.0.5Al₂O₃. In another embodiment, the Li-stuffed garnet herein has a composition of Li₇Li₃Zr₂O₁₂.0.75Al₂O₃.

As used herein, garnet does not include YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the phrase “inorganic solid-state electrolyte” is used interchangeably with the phrase “solid separator” refers to a material which does not include carbon and which conducts atomic ions (e.g., Li⁺) but does not conduct electrons. An inorganic solid-state electrolyte is a solid material suitable for electrically isolating the positive and negative electrodes of a lithium secondary battery while also providing a conduction pathway for lithium ions. Example inorganic solid-state electrolytes include oxide electrolytes and sulfide electrolytes, which are further defined below. Non-limiting example sulfide electrolytes are found, for example, in U.S. Pat. No. 9,172,114, which issued Oct. 27, 2015, and also in US Patent Application Publication No. 2017-0162901 A1, titled LITHIUM, PHOSPHORUS, SULFUR, AND IODINE INCLUDING ELECTROLYTE AND CATHOLYTE COMPOSITIONS, ELECTROLYTE MEMBRANES FOR ELECTROCHEMICAL DEVICES, AND ANNEALING METHODS OF MAKING THESE ELECTROLYTES AND CATHOLYTES, which published Jun. 8, 2017 from U.S. patent application Ser. No. 15/367,103, filed Dec. 1, 2016, which are incorporated by reference herein in their entireties. Non-limiting example oxide electrolytes are found, for example, in US Patent Application Publication No. 2015-0200420 A1, which published Jul. 16, 2015, which is incorporated by reference herein in its entirety. In some examples, the inorganic solid-state electrolyte also includes a polymer.

As used herein, examples of the materials in International Patent Application PCT Patent Application Nos. PCT/US2014/059575 and PCT/US2014/059578, GARNET MATERIALS FOR LI SECONDARY BATTERIES AND METHODS OF MAKING AND USING GARNET MATERIALS, filed Oct. 7, 2014, which is incorporated by reference herein in its entirety, are suitable for use as the inorganic solid-state electrolytes described herein, also as the oxide based electrolytes, described herein, and also as the garnet electrolytes, described herein.

As used herein the term “making” refers to the process or method of forming or causing to form the object that is made. For example, making an energy storage electrode includes the process, process steps, or method of causing the electrode of an energy storage device to be formed. The end result of the steps constituting the making of the energy storage electrode is the production of a material that is functional as an electrode.

As used herein, the phrase “providing” refers to the provision of, generation or, presentation of, or delivery of that which is provided.

As used herein, the phrase “garnet-type electrolyte” refers to an electrolyte that includes a garnet or lithium stuffed garnet material described herein as the ionic conductor.

As used herein, the phrase “subscripts and molar coefficients in the empirical formulas are based on the quantities of raw materials initially batched to make the described examples” means the subscripts, (e.g., 7, 3, 2, 12 in Li₇La₃Zr₂O₁₂ and the coefficient 0.35 in 0.35Al₂O₃) refer to the respective elemental ratios in the chemical precursors (e.g., LiOH, La₂O₃, ZrO₂, Al₂O₃) used to prepare a given material, (e.g., Li₇La₃Zr₂O₁₂.0.35Al₂O₃). As used here, the phrase “characterized by the formula” refers to a molar ratio of constituent atoms either as batched during the process for making that characterized material or as empirically determined.

As used herein, the term “solvent” refers to a liquid that is suitable for dissolving or solvating a component or material described herein. For example, a solvent includes a liquid, e.g., nitrile or dinitrile solvent, which is suitable for dissolving a component, e.g., the salt, used in the electrolyte.

As used herein, the phrase “nitrile” or “nitrile solvent” refers to a hydrocarbon substituted by a cyano group or nitrile group, or a solvent which includes a cyano (i.e., —C≡N) substituent bonded to the solvent. Nitrile solvents may include dinitrile solvents.

As used herein, the phrase “dinitrile” or “dinitrile solvent” refers to a hydrocarbon chain, linear or non-linear, wherein the hydrocarbon chain comprises at least two cyano (i.e., —C≡N) groups. In some cases, the dinitrile or dinitrile solvent comprises a linear hydrocarbon chain. Example dinitrile solvents are characterized by Formula (I):

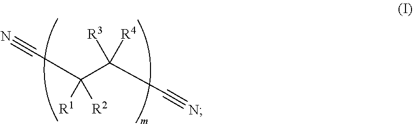

wherein:
R¹, R², R³, and R⁴ are, independently in each instance, selected from —CN, —NO₂, —CO₂, —SO₄, —H, —SO₃, —SO₂, —CH₂—SO₃, —CHF—SO₃, —CF₂—SO₃, —F, —Cl, —Br, and —I; and wherein subscript m is an integer from 1 to 1000.

Some exemplary nitrile and dinitrile solvents include, but are not limited to, adiponitrile (hexanedinitrile), acetonitrile, benzonitrile, butanedinitrile (succinonitrile), butyronitrile, decanenitrile, ethoxyacetonitrile, fluoroacetonitrile, glutaronitrile, hexanenitrile, heptanenitrile, heptanedinitrile, iso-butyronitrile, malononitrile (propanedinitrile), malonodinitrile, methoxyacetonitrile, nitroacetonitrile, nonanenitrile, nonanedinitrile, octanedinitrile (suberodinitrile), octanenitrile, propanenitrile, pentanenitrile, pentanedinitrile, sebaconitrile (decanedinitrile), succinonitrile, and combinations thereof.

As used herein, the phrase “organic sulfur-including solvent” refers to a solvent selected from ethyl methyl sulfone, dimethyl sulfone, sulfolane, allyl methyl sulfone, butadiene sulfone, butyl sulfone, methyl methanesulfonate, and dimethyl sulfite.

As used herein, the phrase “bonding layer” refers to an ionically conductive layer between two other layers, e.g., between the cathode and the solid separator. Exemplary bonding layers include the gel electrolytes, and related separator bonding agents, set forth in US Patent Application Publication No. 2017-0331092 published Nov. 16, 2017 (U.S. application Ser. No. 15/595,755 filed May 15, 217), the entire contents of which are herein incorporated by reference in its entirety for all purposes.

As used herein, the term “HOMO” or “Highest Occupied Molecular Orbital” refers to the energy of the electron occupying the highest occupied molecular orbital, as referenced to the vacuum energy. As used herein, the term “LUMO” refers to “Lowest Unoccupied Molecular Orbital.” HOMO and LUMO energy levels are calculated by DFT calculations referenced to the vacuum level. Unless otherwise specified, the DFT calculations use a B3LYP functional for exchange and correlation and a 6-311++g** basis set.

As used herein, the phrase “stability window” refers to the voltage range within which a material exhibits no reaction which materially or significantly degrades the material's function in an electrochemical cell. It may be measured in an electrochemical cell by measuring cell resistance and Coulombic efficiency during charge/discharge cycling. For voltages within the stability window (i.e. the working electrode vs reference electrode within the stability window), the increase of cell resistance is low. For example, this resistance increase may be less than 1% per 100 cycles. For example, the material is stable at 4V v. Li. For another example, the material is stable at 4V or greater v. Li. For another example, the material is stable at 4V, 4.1V, 4.2V, 4.3V, 4.4V, 4.5V, 4.6V, 4.7V, 4.8V, 4.9V. 5V, 5.1V, or 5.2V v. Li. For example, the material is stable at 5.2V or greater v. Li.

As used herein, the term “a high voltage-stable catholyte” refers to a catholyte which does not react at high voltage (4.2 V or higher versus Li metal) in a way that materially or significantly degrades the ionic conductivity of the catholyte when held at high voltage at room temperature for one week. Herein, a material or significant degradation in ionic conductivity is a reduction in ionic conductivity by an order of magnitude or more. For example, if the catholyte has an ionic conductivity of 10 E-3 S/cm, and when charged to 4.2V or higher the catholyte has an ionic conductivity of 10 E-4 S/cm, then the catholyte is not stable at 4.2V or higher since its ionic conductivity materially and significantly degraded at that voltage.” As used herein, the term “high voltage” means at least 4.2V versus lithium metal (i.e., v. Li). High voltage may also refer to higher voltage, e.g., 4.3, 4.4, 4.5, 4.6, 4.7, 4.8. 4.9, 5.0 V or higher.

As used herein, “stable at 4V or greater v. Li” refers to a material that does not react at high voltage 4V or greater with respect to a lithium metal anode in a way that materially or significantly degrades the ionic conductivity. As used herein, “stable at 4V, 4.1V, 4.2V, 4.3V, 4.4V, 4.5V, 4.6V, 4.7V, 4.8V, 4.9V, 5.0V, 5.1V, or 5.2V v. Li,” refers to a material that does not react at the recited voltage with respect to a lithium metal anode in a way that materially or significantly degrades the ionic conductivity.

As used herein, the term “chemically compatible” means that two or more materials or chemicals are chemically compatible with each other if the materials can be physically exposed to each other and the materials do not react in a way which materially or significantly degrades the electrochemical performance within a short amount of time, such as 100 days, 1 year, 5 years, or longer. As used herein, a short time includes 1 year unless specified otherwise to the contrary. Herein, electrochemical performance refers to either ionic conductivity or area-specific resistance (ASR). A material or significant degradation in ionic conductivity is a degradation by an order of magnitude or more. A material or significant degradation in ASR is a degradation by a factor of 2 or more when held at room temperature for one week.

As used herein, the term “LiBOB” refers to lithium bis(oxalato)borate.

As used herein, the term “LiBETI” refers to lithium bis(perfluoroethanesulfonyl)imide.

As used herein, the term “LIFSI” refers to lithium bis(fluorosulfonyl)imide.

As used herein, the term “LiTFSI” refer to lithium bis-trifluoromethanesulfonimide.

As used herein, voltage is set forth with respect to lithium (i.e., V vs. Li) metal unless stated otherwise.

As used herein, the term “LiBHI” refers to a combination of LiBH₄ and LiX, wherein X is Br, Cl, I, or a combination thereof.

As used herein, the term “LiBNHI” refers to a combination of LiBH₄, LiNH₂, and LiX, wherein X is Br, Cl, I, or combinations thereof.

As used herein, the term “LiBHCl” refers to a combination of LiBH₄ and LiCl.

As used herein, the term “LiBNHCl” refers to a combination of LiBH₄, LiNH₂, and LiCl.

As used herein, the term “LiBHBr” refers to a combination of LiBH₄ and LiBr.

As used herein, the term “LiBNHBr” refers to a combination of LiBH₄, LiNH₂, and LiBr.

As used herein, the term “AN” refers to acrylonitrile.

As used herein, the term “PAN” refers to poly(acrylonitrile).

As used herein, the term “LiPON” refers to solid state electrolyte comprising lithium, phosphorus, oxygen and nitrogen and is referred to as lithium phosphorus oxy-nitride. LiPON can be characterized by the formula LiₓPO_{y}N_{z} in which x=2y+3z-5.

As used herein, the term “LiSON” refers to refers to solid state electrolyte comprising lithium, sulfur, oxygen and nitrogen and is referred to as lithium sulfur oxy-nitride. LiSON can be characterized by the formula LiₓSO_{y}N_{z} in which x=2y+3z-2.

Viscosity can be measured using a Brookfield viscometer DV2T.

As used herein, the term “monolith” refers to a shaped, fabricated article with a homogenous microstructure with no structural distinctions observed optically, which has a form factor top surface area between 10 cm² and 500 cm².

As used herein, the term “vapor pressure” refers to the equilibrium pressure of a gas above its liquid at the same temperature in a closed system. Measurement procedures may consist of purifying the test substance, isolating it in a container, evacuating any foreign gas, then measuring the equilibrium pressure of the gaseous phase of the substance in the container at different temperatures. Better accuracy may be achieved when care is taken to ensure that the entire substance and its vapor are at the prescribed temperature. This may be done with the use of an isoteniscope, by submerging the containment area in a liquid bath.

As used herein, the term “lithium salt” refers to a lithium-containing compound that is a solid at room temperature that at least partially dissociates when immersed in a solvent such as EMC. Lithium salts may include but are not limited to LiPF₆, LiBOB, LiTFSi, LiFSI, LiAsF₆, LiClO₄, LiI, LiBETI, LiBF₄. As used herein, the term “carbonate solvent” refers to a class of solvents containing a carbonate group C(═O)(O—)₂. Carbonate solvents include but are not limited to ethylene carbonate, dimethyl carbonate, propylene carbonate, diethyl carbonate, ethyl methyl carbonate, dimethyl ethylene carbonate, isobutylene carbonate, nitroethyl carbonate, Monofluoroethylene carbonate, fluoromethyl ethylene carbonate, 1,2-butylene carbonate, methyl propyl carbonate, isopropyl methyl carbonate, etc.

As used herein, area-specific resistance (ASR) is measured by electrochemical cycling using Arbin or Biologic unless otherwise specified to the contrary.

As used herein, ionic conductivity is measured by electrical impedance spectroscopy methods known in the art.

As used herein, high voltage means 4V or larger versus a lithium metal reference electrode (which is at 0V).

As used herein, the term “aprotic polymer” refers to a polymer that does not have a labile proton, a polymer that may not readily donate a proton.

As used herein, the term “alkyl” refers to saturated aliphatic groups including straight-chain, branched-chain, cyclic groups, and combinations thereof, having the number of carbon atoms specified, or if no number is specified, having up to 12 carbon atoms. “Straight-chain alkyl” or “linear alkyl” groups refers to alkyl groups that are neither cyclic nor branched, commonly designated as “n-alkyl” groups. Examples of alkyl groups include, but are not limited to, groups such as methyl, ethyl, n-propyl, isopropyl, butyl, n-butyl, isobutyl, sec-butyl, t-butyl, pentyl, n-pentyl, hexyl, heptyl, octyl, nonyl, decyl, undecyl, dodecyl, neopentyl, cyclopropyl, cyclobutyl, cyclopentyl, cyclohexyl, and adamantyl. Cycloalkyl groups can consist of one ring, including, but not limited to, groups such as cycloheptyl, or multiple fused rings, including, but not limited to, groups such as adamantyl or norbornyl.

As used herein, the term “butyl” refers to n-butyl, sec-butyl, iso-butyl, or tert-butyl (t-butyl).

As used herein, the term “storage modulus” or “the bulk modulus,” is equivalent to a Young's modulus, i.e., elastic modulus or modulus of elasticity. The variables E and G (as well as E′, E″, G′, and G″) are used to represent modulus values. Its value is determined by the slope of a material's stress versus strain curve prior to permanent deformation (e.g. pressure vs. % deformation). The elastic modulus may be published by the manufacturer or may be tested by a person having ordinary skill in the art (e.g., engineering). Stiff materials have a high elastic modulus. Pliable materials have a low elastic modulus. For rubbery fluid like materials (materials with non-linear stress strain curves), the bulk modulus is a function of the elastic modulus and is approximately 10× the elastic modulus, though in practice it is actually a function of the material's elastic modulus (E) and poisson's ration (v). A modulus is measured in one of the x, y, or z planes. A stress is applied to a material parallel to one of the x, y, or z planes. As stress is applied to a plane, the relationship between its dimensional change and the dimensional changes of orthogonal planes. Representative modulus values are found in The CES 2009 EDUPACK. Cambridge University, copyright Granta Design January 2009, e.g., page 28 therein, the entire contents of which are herein incorporated by reference in its entirety for all purposes.

As used herein, the term “G′/G″ modulus ratio” refers to ratio of stress versus strain. As used herein, the term “G′/G″ modulus ratio” is determined as is the ratio E′/E″ in Example 2.

As used herein, the term “cyano functional group” and the term “nitrile functional group” can be used interchangeably. The group is represented by —CN. Additionally either term can be used interchangeably with the term “cyano functionality.”

As used herein, the phrase “the molecular weight of the polymer” refers to a Mₙ—number average molecular weight, as determined by NMR spectroscopy, unless explicitly expressed otherwise.

### B. General

Previous researchers have prepared high voltage electrochemical batteries that have poly(acrylonitrile) (PAN) polymer electrolyte separators. However, these PAN polymers were made using physical cross-linking. Physical cross linking results in non-uniform, inhomogeneous structures, which vary with respect to molecular weight, amount, type, length, and uniformity of cross-linking. Physical cross linking leads to stochastic linking results, e.g., non-uniform MW distributions or cross-linker lengths.

Set forth herein are PAN gels that are chemically cross-linked. Chemically cross-linking may provide a series of advantages, such as the following:
better mechanical properties. The gels disclosed herein are swollen with a solvent and a lithium salt but they may behave like a solid. This is measured by the modulus ratio of G′/G″. Herein G′ is larger than G″. This is similar to high quality rubbers used in tubing.
better voltage stability. The methods disclosed herein rely on nitrogen-containing linkages, e.g., amide bonds. Amide bonds are stable to high voltages. Ester and ether bonds are not stable to high voltages. The methods disclosed herein do not use ester or ether linking groups.
better uptake of swelling solvents.
uniformity of molecular weight, branching, crosslinking. These properties are tunable as well.
getting closer to a model network which may be similar to a perfect 3-D cargo net with no loose polymer ends. This does not happen for physical cross-linking of PAN.
ability to attach quaternary ammonium cationic functional groups.
compositions including chemically cross-linked polymer have a wide electrochemical stability window (ESW).

Provided herein is a composition including a chemically cross-linked polymer comprising cyano (—CN) functional groups and a solvent selected from the group consisting of a nitrile, a dinitrile, or a combination thereof. Alternatively provided herein is a composition including a chemically cross-linked polymer comprising nitrile functional groups and a solvent selected from the group consisting of a nitrile, a dinitrile, or a combination thereof. Alternatively provided herein is a composition including a chemically cross-linked polymer and a solvent selected from the group consisting of a nitrile, a dinitrile, or a combination thereof. In some embodiments, the chemically cross-linked polymer comprising at least one cyano (—CN) functional group is an aprotic polymer. In some cases, the polymer does not comprise a labile hydrogen atom.

In some cases, a chemically cross-linked polymer disclosed herein comprises a labile hydrogen atom. In some cases, the chemically cross-linked polymer is a protic polymer.

In some embodiments, the composition further includes a lithium salt.

In some embodiments, including any of foregoing embodiments, the composition has a G′/G″ modulus ratio greater than or equal to 1.

In some embodiments, including any of foregoing embodiments, the composition is closer to a model network defined as 3-D cargo net with no loose ends. In examples of this model network, the chemical cross-linking points are much smaller than physically cross-linked points would be, and, further, the cross-linking points are arranged in three dimensions in a uniform manner.

In some embodiments, including any of foregoing embodiments, the composition does not include any ester groups.

In some embodiments, including any of foregoing embodiments, the composition does not include any ether groups.

In some embodiments, including any of foregoing embodiments, the composition does not include any ester or ether groups.

In some embodiments, including any of foregoing embodiments, the composition includes amide containing linking groups.

In some embodiments, including any of foregoing embodiments, the composition includes urea containing linking groups.

In some embodiments, including any of foregoing embodiments, the composition is stable at 4V or greater v. Li.

In some embodiments, including any of foregoing embodiments, the composition is stable at 4V, 4.1V, 4.2V, 4.3V, 4.4V, 4.5V, 4.6V, 4.7V, 4.8V, 4.9V. 5V, 5.1V, or 5.2V v. Li.

In some embodiments, including any of foregoing embodiments, the composition is stable at 5.2V or greater v. Li.

In some embodiments of the composition provided herein, including any of foregoing embodiments, the polymer is a poly(acrylonitrile) (PAN) or derivative thereof.

In some embodiments of the composition provided herein, including any of foregoing embodiments, the PAN comprises amide functional groups.

In some embodiments of the composition provided herein, including any of foregoing embodiments, the PAN comprises urea functional groups.

In some embodiments of the composition provided herein, including any of foregoing embodiments, the PAN does not comprise ester functional groups.

In some embodiments of the composition provided herein, including any of foregoing embodiments, the nitrile solvent is selected from adiponitrile (hexanedinitrile), acetonitrile, benzonitrile, butanedinitrile (succinonitrile), butyronitrile, decanenitrile, ethoxyacetonitrile, fluoroacetonitrile, glutaronitrile, hexanenitrile, heptanenitrile, heptanedinitrile, iso-butyronitrile, malononitrile (propanedinitrile or malonodinitrile), methoxyacetonitrile, nitroacetonitrile, nonanenitrile, nonanedinitrile, octanedinitrile (suberodinitrile), octanenitrile, propanenitrile, pentanenitrile, pentanedinitrile, sebaconitrile (decanedinitrile), succinonitrile, and combinations thereof.

In some embodiments of the composition provided herein, including any of foregoing embodiments, the solvent is selected from adiponitrile (hexanedinitrile), acetonitrile, benzonitrile, butanedinitrile (succinonitrile), butyronitrile, decanenitrile, ethoxyacetonitrile, fluoroacetonitrile, glutaronitrile, hexanenitrile, heptanenitrile, heptanedinitrile, iso-butyronitrile, malononitrile (propanedinitrile or malonodinitrile), methoxyacetonitrile, nitroacetonitrile, nonanenitrile, nonanedinitrile, octanedinitrile (suberodinitrile), octanenitrile, propanenitrile, pentanenitrile, pentanedinitrile, sebaconitrile (decanedinitrile), succinonitrile, and combinations thereof.

In some embodiments of the composition provided herein, including any of foregoing embodiments, the nitrile solvent is adiponitrile.

In some embodiments of the composition provided herein, including any of foregoing embodiments, the polymer is swollen with adiponitrile.

In some embodiments of the composition provided herein, including any of foregoing embodiments, the nitrile solvent is acetonitrile.

In some embodiments of the composition provided herein, including any of foregoing embodiments, the polymer is swollen with acetonitrile.

In some embodiments of the composition provided herein, including any of foregoing embodiments, the nitrile solvent is benzonitrile.

In some embodiments of the composition provided herein, including any of foregoing embodiments, the polymer is swollen with benzonitrile.

In some embodiments of the composition provided herein, including any of foregoing embodiments, the nitrile solvent is butanedinitrile.

In some embodiments of the composition provided herein, including any of foregoing embodiments, the polymer is swollen with butanedinitrile.

In some embodiments of the composition provided herein, including any of foregoing embodiments, the nitrile solvent is butyronitrile.

In some embodiments of the composition provided herein, including any of foregoing embodiments, the polymer is swollen with butyronitrile.

In some embodiments of the composition provided herein, including any of foregoing embodiments, the nitrile solvent is decanenitrile.

In some embodiments of the composition provided herein, including any of foregoing embodiments, the polymer is swollen with decanenitrile.

In some embodiments of the composition provided herein, including any of foregoing embodiments, the nitrile solvent is ethoxyacetonitrile.

In some embodiments of the composition provided herein, including any of foregoing embodiments, the polymer is swollen with ethoxyacetonitrile.

In some embodiments of the composition provided herein, including any of foregoing embodiments, the nitrile solvent is fluoroacetonitrile.

In some embodiments of the composition provided herein, including any of foregoing embodiments, the polymer is swollen with fluoroacetonitrile.

In some embodiments of the composition provided herein, including any of foregoing embodiments, the nitrile solvent is glutaronitrile.

In some embodiments of the composition provided herein, including any of foregoing embodiments, the polymer is swollen with glutaronitrile.

In some embodiments of the composition provided herein, including any of foregoing embodiments, the nitrile solvent is hexanenitrile.

In some embodiments of the composition provided herein, including any of foregoing embodiments, the polymer is swollen with hexanenitrile.

In some embodiments of the composition provided herein, including any of foregoing embodiments, the nitrile solvent is heptanenitrile,

In some embodiments of the composition provided herein, including any of foregoing embodiments, the polymer is swollen with heptanenitrile,

In some embodiments of the composition provided herein, including any of foregoing embodiments, the nitrile solvent is heptanedinitrile,

In some embodiments of the composition provided herein, including any of foregoing embodiments, the polymer is swollen with heptanedinitrile,

In some embodiments of the composition provided herein, including any of foregoing embodiments, the nitrile solvent is iso-butyronitrile,

In some embodiments of the composition provided herein, including any of foregoing embodiments, the polymer is swollen with iso-butyronitrile.

In some embodiments of the composition provided herein, including any of foregoing embodiments, the nitrile solvent is malononitrile.

In some embodiments of the composition provided herein, including any of foregoing embodiments, the polymer is swollen with malononitrile.

In some embodiments of the composition provided herein, including any of foregoing embodiments, the nitrile solvent is methoxyacetonitrile.

In some embodiments of the composition provided herein, including any of foregoing embodiments, the polymer is swollen with methoxyacetonitrile.

In some embodiments of the composition provided herein, including any of foregoing embodiments, the nitrile solvent is nitroacetonitrile.

In some embodiments of the composition provided herein, including any of foregoing embodiments, the polymer is swollen with nitroacetonitrile.

In some embodiments of the composition provided herein, including any of foregoing embodiments, the nitrile solvent is nonanenitrile.

In some embodiments of the composition provided herein, including any of foregoing embodiments, the polymer is swollen with nonanenitrile.

In some embodiments of the composition provided herein, including any of foregoing embodiments, the nitrile solvent is nonanedinitrile.

In some embodiments of the composition provided herein, including any of foregoing embodiments, the polymer is swollen with nonanedinitrile.

In some embodiments of the composition provided herein, including any of foregoing embodiments, the nitrile solvent is octanedinitrile.

In some embodiments of the composition provided herein, including any of foregoing embodiments, the polymer is swollen with octanedinitrile.

In some embodiments of the composition provided herein, including any of foregoing embodiments, the nitrile solvent is octanenitrile.

In some embodiments of the composition provided herein, including any of foregoing embodiments, the polymer is swollen with octanenitrile.

In some embodiments of the composition provided herein, including any of foregoing embodiments, the nitrile solvent is propanenitrile.

In some embodiments of the composition provided herein, including any of foregoing embodiments, the polymer is swollen with propanenitrile.

In some embodiments of the composition provided herein, including any of foregoing embodiments, the nitrile solvent is pentanenitrile.

In some embodiments of the composition provided herein, including any of foregoing embodiments, the polymer is swollen with pentanenitrile.

In some embodiments of the composition provided herein, including any of foregoing embodiments, the nitrile solvent is pentanedinitrile.

In some embodiments of the composition provided herein, including any of foregoing embodiments, the polymer is swollen with pentanedinitrile.

In some embodiments of the composition provided herein, including any of foregoing embodiments, the nitrile solvent is sebaconitrile.

In some embodiments of the composition provided herein, including any of foregoing embodiments, the polymer is swollen with sebaconitrile.

In some embodiments of the composition provided herein, including any of foregoing embodiments, the nitrile solvent is succinonitrile.

In some embodiments of the composition provided herein, including any of foregoing embodiments, the polymer is swollen with succinonitrile.

In some embodiments of the composition provided herein, including any of foregoing embodiments, the polymer is of any one of the following formulas:

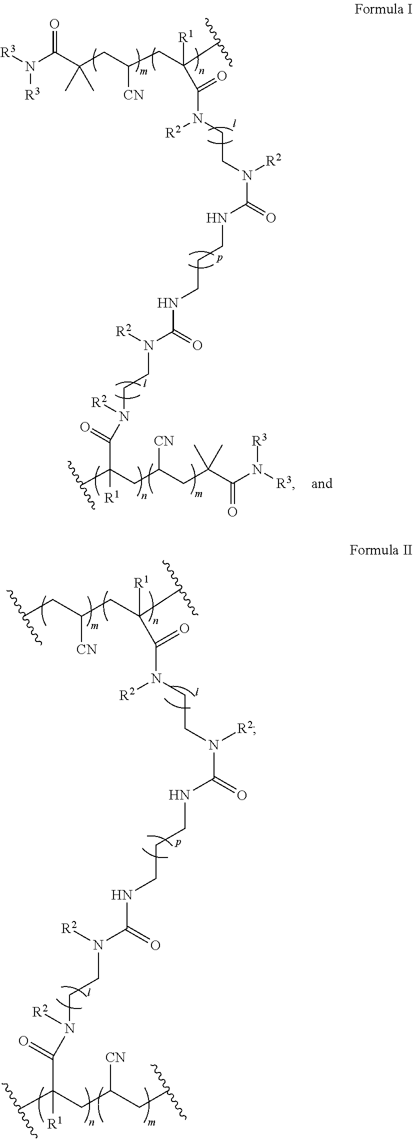

wherein: R¹ is selected from H and alkyl; R² is selected from methyl, ethyl, propyl, butyl, pentyl, hexyl, heptyl, octyl, nonyl, and decyl; subscript l is an integer selected from 1 to 10 inclusive; subscript p is an integer selected from 1 to 10 inclusive; R³ is selected from methyl, ethyl, propyl, butyl, pentyl, hexyl, heptyl, octyl, nonyl, and decyl; subscripts n and m represent the numbers of repeating units in the parentheses respectively; and the symbol, [symbol] , refers to the point of attachment of the illustrated formula to the remainder of the polymer. In some examples, n and m are independently an integer from 1 to 5,000 or 1 to 10,000 inclusive. In some examples, n is 70 to 270 and m is 2 to 13. In some examples, n is far larger than m. In some examples, n determines the molecular weight of PAN. In some examples, n is 30 to 5000 and m=2 to 100. In some examples, m is 70 to 270 and n is 2 to 13. In some examples, m is far larger than n. In some examples, m determines the molecular weight of PAN. In some examples, m is 30 to 5000 and n is 2 to 100. In some examples, subscript p is 1. In some examples, subscript p is 2. In some examples, subscript p is 3. In some examples, subscript p is 4. In some examples, subscript p is 5. In some examples, subscript p is 6. In some examples, subscript p is 7. In some examples, subscript p is 8. In some examples, subscript p is 9. In some examples, subscript p is 10.

In some embodiments of the composition provided herein, including any of foregoing embodiments, R¹ is —H or methyl; R² is selected from methyl and t-butyl; subscript 1 is selected from 1, 3, and 5; subscript p is 4; and R³ is ethyl. In some examples, R² is methyl. In some examples, R² is butyl.

In some embodiments of the composition provided herein, including any of foregoing embodiments, R¹ is H. In some embodiments of the composition provided herein, including any of foregoing embodiments, R¹ is alkyl. Alkyl is methyl, ethyl, propyl, butyl, pentyl, pentyl, hexyl, heptyl, octyl, nonyl, or decyl.

In some embodiments of the composition provided herein, including any of foregoing embodiments, R² is methyl. In some embodiments of the composition provided herein, including any of foregoing embodiments, R² is ethyl. In some embodiments of the composition provided herein, including any of foregoing embodiments, R² is propyl. In some embodiments of the composition provided herein, including any of foregoing embodiments, R² is butyl. In some embodiments of the composition provided herein, including any of foregoing embodiments, R² is pentyl. In some embodiments of the composition provided herein, including any of foregoing embodiments, R² is hexyl. In some embodiments of the composition provided herein, including any of foregoing embodiments, R² is heptyl. In some embodiments of the composition provided herein, including any of foregoing embodiments, R² is octyl. In some embodiments of the composition provided herein, including any of foregoing embodiments, R² is nonyl. In some embodiments of the composition provided herein, including any of foregoing embodiments, R² is decyl. In some embodiments of the composition provided herein, including any of foregoing embodiments, butyl refers to n-butyl, sec-butyl, iso-butyl, or tert-butyl (t-butyl). In some embodiments of the composition provided herein, including any of foregoing embodiments, pentyl refers to n-pentyl, tert-pentyl, neo-pentyl, iso-pentyl, sec-pentyl, or 3-pentyl.

In some embodiments of the composition provided herein, including any of foregoing embodiments, subscript l is 1, 2, 3, 4, 5, 6, 7, 8, 9, or 10.

In some embodiments of the composition provided herein, including any of foregoing embodiments, subscript p is 1, 2, 3, 4, 5, 6, 7, 8, 9, or 10.

In some embodiments of the composition provided herein, including any of foregoing embodiments, R³ is methyl. In some embodiments of the composition provided herein, including any of foregoing embodiments, R³ is ethyl. In some embodiments of the composition provided herein, including any of foregoing embodiments, R³ is propyl. In some embodiments of the composition provided herein, including any of foregoing embodiments, R³ is butyl. In some embodiments of the composition provided herein, including any of foregoing embodiments, R³ is pentyl. In some embodiments of the composition provided herein, including any of foregoing embodiments, R³ is hexyl. In some embodiments of the composition provided herein, including any of foregoing embodiments, R³ is heptyl. In some embodiments of the composition provided herein, including any of foregoing embodiments, R³ is octyl. In some embodiments of the composition provided herein, including any of foregoing embodiments, R³ is nonyl. In some embodiments of the composition provided herein, including any of foregoing embodiments, R³ is decyl.

In some embodiments of the composition provided herein, including any of foregoing embodiments, subscript n is an integer from 1 to 5000, 1 to 4000, 1 to 3000, 1 to 2000, 1 to 1000, 1 to 900, 1 to 800, 1 to 700, 1 to 600, 1 to 500, 1 to 400, 1 to 300, 1 to 200, 1 to 100, 1 to 50, 50 to 1000, 50 to 900, 50 to 800, 50 to 700, 50 to 600, 50 to 500, 50 to 400, 50 to 300, 50 to 200, 50 to 100, 100 to 900, 100 to 800, 100 to 700, 100 to 600, 100 to 500, 100 to 400, 100 to 300, 100 to 200, 200 to 900, 200 to 800, 200 to 700, 200 to 600, 200 to 500, 200 to 400, 200 to 300, 300 to 900, 300 to 800, 300 to 700, 300 to 600, 300 to 500, or 300 to 400, inclusive.

In some embodiments of the composition provided herein, including any of foregoing embodiments, subscript m is an integer from 1 to 5000, 1 to 4000, 1 to 3000, 1 to 2000, 1 to 1000, 1 to 900, 1 to 800, 1 to 700, 1 to 600, 1 to 500, 1 to 400, 1 to 300, 1 to 200, 1 to 100, 1 to 50, 50 to 1000, 50 to 900, 50 to 800, 50 to 700, 50 to 600, 50 to 500, 50 to 400, 50 to 300, 50 to 200, 50 to 100, 100 to 900, 100 to 800, 100 to 700, 100 to 600, 100 to 500, 100 to 400, 100 to 300, 100 to 200, 200 to 900, 200-800, 200 to 700, 200 to 600, 200 to 500, 200 to 400, 200 to 300, 300 to 900, 300 to 800, 300 to 700, 300 to 600, 300 to 500, or 300 to 400, inclusive.

In some embodiment, m is 70 to 270 and n is 2 to 13, inclusive. In some embodiments, m is from 30 to 5000 and n is from 2 to 100, inclusive. In some embodiments, m is selected from 30 to 4000, 30 to 3000, 30 to 2000, 30 to 2000, 30 to 500, 30 to 400, 30 to 300, and 30 to 200, and n is selected from 2 to 100, 2 to 90, 2 to 80, 2 to 70, 2 to 60, 2 to 60, 2 to 50, 2 to 40, 2 to 30, 2 to 20, 2 to 15, 2 to 10, 2 to 8, and 2 to 6, inclusive.

In some embodiment, n is 70 to 270 and m is 2 to 13, inclusive. In some embodiments, n is from 30 to 5000 and m is from 2 to 100, inclusive. In some embodiments, n is selected from 30 to 4000, 30 to 3000, 30 to 2000, 30 to 2000, 30 to 500, 30 to 400, 30 to 300, and 30 to 200 and m is selected from 2 to 100, 2 to 90, 2 to 80, 2 to 70, 2 to 60, 2 to 60, 2 to 50, 2 to 40, 2 to 30, 2 to 20, 2 to 15, 2 to 10, 2 to 8, and 2 to 6, inclusive.

In some embodiments of the composition provided herein, including any of foregoing embodiments, the polymer is of the following formula:

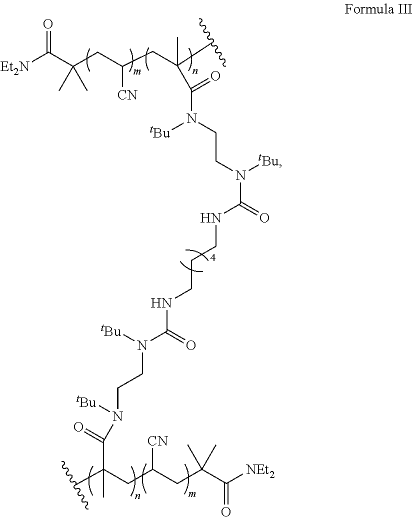

wherein ^{t}Bu represents t-butyl.

In some embodiments of the composition provided herein, including any of foregoing embodiments, the polymer is made by polymerizing a monomer selected from

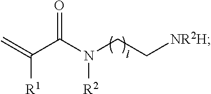

wherein R¹ is selected from H and alkyl; R² is selected from methyl, ethyl, propyl, butyl, pentyl, hexyl, heptyl, octyl, nonyl, and decyl; and subscript l is an integer from 1 to 10 inclusive.

In some embodiments of the composition provided herein, including any of foregoing embodiments, wherein R¹ is methyl.

In some embodiments of the composition provided herein, including any of foregoing embodiments, R² is methyl, ethyl, propyl, or butyl. In some embodiments, including any of foregoing embodiments, R² is butyl. In some embodiments, including any of foregoing embodiments, R² is t-butyl.

In some embodiments of the composition provided herein, including any of foregoing embodiments, subscript l is 1, 2, 3, 4, or 5.

In some embodiments of the composition provided herein, including any of foregoing embodiments, R¹ is H. In some embodiments of the composition provided herein, including any of foregoing embodiments, R¹ is alkyl. Alkyl is methyl, ethyl, propyl, butyl, pentyl, hexyl, heptyl, octyl, nonyl, or decyl.

In some embodiments of the composition provided herein, including any of foregoing embodiments, R² is methyl. In some embodiments of the composition provided herein, including any of foregoing embodiments, R² is ethyl. In some embodiments of the composition provided herein, including any of foregoing embodiments, R² is propyl. In some embodiments of the composition provided herein, including any of foregoing embodiments, R² is butyl. In some embodiments of the composition provided herein, including any of foregoing embodiments, R² is pentyl. In some embodiments of the composition provided herein, including any of foregoing embodiments, R² is hexyl. In some embodiments of the composition provided herein, including any of foregoing embodiments, R² is heptyl. In some embodiments of the composition provided herein, including any of foregoing embodiments, R² is octyl. In some embodiments of the composition provided herein, including any of foregoing embodiments, R² is nonyl. In some embodiments of the composition provided herein, including any of foregoing embodiments, R² is decyl.

In some embodiments of the composition provided herein, including any of foregoing embodiments, subscript l is 1, 2, 3, 4, 5, 6, 7, 8, 9, or 10.

In some embodiments of the composition provided herein, including any of foregoing embodiments, the molecular weight of the polymer is between 5,000 and 17,000 (Mₙ—number average).

In some embodiments of the composition provided herein, including any of foregoing embodiments, the molecular weight of the polymer is between 5,000 and 6,000; 5.000 and 7,000; 5,000 and 8,000; 5,000 and 9,000; 5,000 and 10,000; 5,000 and 11,000; 5.000 and 12,000; 5,000 and 13,000; 5,000 and 14,000; 5,000 and 15,000; or 5,000 and 16.000 (Mₙ—number average).

In some embodiments of the composition provided herein, including any of foregoing embodiments, the dispersity of the polymer is between 0.5 and 1.2. In some embodiments, including any of foregoing embodiments, the dispersity of the polymer is 1.11.

In some embodiments of the composition provided herein, including any of foregoing embodiments, the storage modulus of the polymer is between 10⁴ and 10⁶ Pa. In some embodiments, the storage modulus of the polymer is between 10^{5.2} and 10^{5.7} Pa.

In some embodiments, including any of foregoing embodiments, the composition comprises a solvent or mixture of solvents, wherein the mixture has a boiling point of greater than 80° C.

In some embodiments, including any of foregoing embodiments, the composition comprises a solvent having a HOMO level of more than 7.2 eV below the vacuum level and up to 11.5 eV below the vacuum level.

In some embodiments, including any of foregoing embodiments, the composition comprises a polar and aprotic solvent.

In some embodiments, including any of foregoing embodiments, the composition comprises a member selected from the group consisting of fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane (i.e., 1,1,2,2-tetrafluoro-3-(1,1,2,2-tetrafluoroethoxy)propane (F-EPE)), fluorinated cyclic carbonate (F-AEC), tris(trimethylsilyl)phosphite (TTSPi), and combinations thereof.

In some embodiments, including any of foregoing embodiments, the composition comprises fluoroethylene carbonate (FEC). In some embodiments, including any of foregoing embodiments, the composition comprises fluoromethyl ethylene carbonate (FMEC). In some embodiments, including any of foregoing embodiments, the composition comprises trifluoroethyl methyl carbonate (F-EMC). In some embodiments, including any of foregoing embodiments, the composition comprises fluorinated 3-(1,1,2,2-tetrafluoroethoxy)-1,1,2,2-tetrafluoropropane (i.e., 1,1,2,2-tetrafluoro-3-(1,1,2,2-tetrafluoroethoxy)propane (F-EPE)). In some embodiments, including any of foregoing embodiments, the composition comprise fluorinated cyclic carbonate (F-AEC). In some embodiments, including any of foregoing embodiments, the composition comprises tris(trimethylsilyl)phosphite (TTSPi).

In some embodiments, including any of foregoing embodiments, the composition comprises a member selected from the group consisting of methylene methanedisulfonate (MMDS), methyl pivalate, 1,2 dioxane, sulfolane, and combinations thereof.

In some embodiments, including any of foregoing embodiments, the composition comprises an organic sulfur-including solvent selected from ethyl methyl sulfone, dimethyl sulfone, sulfolane, allyl methyl sulfone, butadiene sulfone, butyl sulfone, methyl methanesulfonate, dimethyl sulfite, and combinations thereof.

In some embodiments, including any of foregoing embodiments, the composition comprises a lithium salt selected from LiPF₆, LiBOB, LiTFSi, LiBF₄, LiClO₄, LiAsF₆, LiFSI, LiClO₄, LiI, and a combination thereof.

In some embodiments, including any of foregoing embodiments, the composition comprises LiPF₆. In some embodiments, including any of foregoing embodiments, the composition comprises LiBOB. In some embodiments, including any of foregoing embodiments, the composition comprises LiTFSi. In some embodiments, including any of foregoing embodiments, the composition comprises LiBF₄. In some embodiments, including any of foregoing embodiments, the composition comprises LiClO₄. In some embodiments, including any of foregoing embodiments, the composition comprises LiAsF₆. In some embodiments, including any of foregoing embodiments, the composition comprises LiFSI. In some embodiments, including any of foregoing embodiments, the composition comprises LiClO₄, In some embodiments, including any of foregoing embodiments, the composition comprises LiI.

In some embodiments, including any of foregoing embodiments, the composition does not comprise

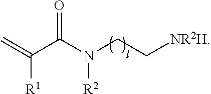

In some embodiments, this monomer is consumed during the reaction. In some embodiments, this monomer is separated from the polymer produced from the monomer.

In some embodiments, including any of foregoing embodiments, the composition does not comprise

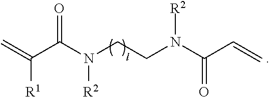

In some embodiments, this monomer is consumed during the reaction. In some embodiments, this monomer is separated from the polymer produced from the monomer.

Provided herein is a process for making a composition, including:
step 1: copolymerizing an acrylonitrile (AN) monomer and a monomer to form a polymer, wherein the monomer comprises amide functional groups; and
step 2: chemically cross-linking the polymer using a bifunctional cross-linker.

Provided herein is a process for making a composition, including:
step 1: copolymerizing an acrylonitrile (AN) and a monomer to form a polymer, wherein the monomer comprises urea functional groups; and
step 2: chemically cross-linking the polymer using a bifunctional cross-linker.

Provided herein is a process for making a composition, including:
step 1: copolymerizing an acrylonitrile (AN) and a methacrylamide to form a polymer, wherein the methacrylamide comprises amide functional groups; and
step 2: chemically cross-linking the polymer using a bifunctional cross-linker.

Provided herein is a process for making a composition, including:
step 1: copolymerizing an acrylonitrile (AN) and a methacrylamide to form a polymer, wherein the methacrylamide comprises urea functional groups; and
step 2: chemically cross-linking the polymer using a bifunctional cross-linker.

In some examples, the monomer is a methacrylamide set forth herein.

In some embodiments of the process provided herein, the monomer comprises secondary amine functional groups.

In some embodiments of the process provided herein, including any of foregoing embodiments, the monomer does not comprise primary amine functional groups.

In some embodiments of the process provided herein, including any of foregoing embodiments, the monomer does not comprise quaternary amine functional groups.

In some embodiments of the process provided herein, including any of foregoing embodiments, the monomer comprises primary amine functional groups.

In some embodiments of the process provided herein, including any of foregoing embodiments, the monomer comprises tertiary amine functional groups.

In some embodiments of the process provided herein, including any of foregoing embodiments, the monomer comprises quaternary amine functional groups.

In some embodiments of the process provided herein, including any of foregoing embodiments, the monomer is a N,N′-dialkyl acrylamide.

In some embodiments of the process provided herein, the methacrylamide comprises secondary amine functional groups.

In some embodiments of the process provided herein, including any of foregoing embodiments, the methacrylamide does not comprise primary amine functional groups.

In some embodiments of the process provided herein, including any of foregoing embodiments, the methacrylamide does not comprise quaternary amine functional groups.

In some embodiments of the process provided herein, including any of foregoing embodiments, the methacrylamide comprises primary amine functional groups.

In some embodiments of the process provided herein, including any of foregoing embodiments, the methacrylamide comprises tertiary amine functional groups.

In some embodiments of the process provided herein, including any of foregoing embodiments, the methacrylamide comprises quaternary amine functional groups.

In some embodiments of the process provided herein, including any of foregoing embodiments, the methacrylamide is a N,N′-dialkyl acrylamide.

In some embodiments of the process provided herein, including any of foregoing embodiments, the monomer is

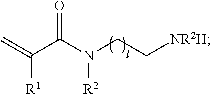

wherein R¹ is selected from H and alkyl; R² is selected from methyl, ethyl, propyl, butyl, pentyl, hexyl, heptyl, octyl, nonyl, and decyl; and subscript l is an integer from 1 to 10.

In some embodiments of the process provided herein, including any of foregoing embodiments, the methacrylamide is

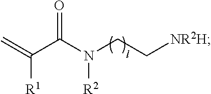

wherein R¹ is methyl; R² is selected from methyl, ethyl, propyl, butyl, pentyl, hexyl, heptyl, octyl, nonyl, and decyl; and subscript l is an integer from 1 to 10.

In some embodiments of the process provided herein, including any of foregoing embodiments, the monomer is

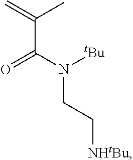

wherein ^{t}Bu represents t-butyl.

In some embodiments of the process provided herein, including any of foregoing embodiments, the methacrylamide is

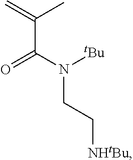

wherein ^{t}Bu represents t-butyl.

In some embodiments of the process provided herein, including any of foregoing embodiments, the AN is

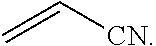

In some embodiments of the process provided herein, including any of foregoing embodiments, the monomer is made by condensing an acryloyl or acryloyl chloride and a symmetric diamine.

In some embodiments of the process provided herein, including any of foregoing embodiments, the methacrylamide is made by condensing a methacryloyl or methacryloyl chloride and a symmetric diamine.

In some embodiments of the process provided herein, including any of foregoing embodiments, the polymer is made by reversible deactivation (living) radical copolymerization.

In some embodiments of the process provided herein, including any of foregoing embodiments, the methacrylamide is made using condensation reagent.

In some embodiments of the process provided herein, including any of foregoing embodiments, the condensation reagent is selected from N,N′-dicyclohexylcarbodiimide (DCC) or 1-[bis(dimethylamino)methylene]-1H-benzotriazolium 3-oxide hexafluorophosphate (HBTU).

In some embodiments of the process provided herein, including any of foregoing embodiments, the acryloyl is

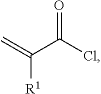

wherein R¹ is selected from —H and alkyl. Alkyl is methyl, ethyl, propyl, butyl, pentyl, pentyl, hexyl, heptyl, octyl, nonyl, or decyl. In some embodiments, R¹ is methyl.

In some embodiments of the process provided herein, including any of foregoing embodiments, the symmetric diamine is

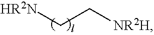

wherein R² is selected from methyl, ethyl, propyl, butyl, pentyl, hexyl, heptyl, octyl, nonyl, and decyl; and subscript l is an integer from 1 to 10. In some embodiments, including any of foregoing embodiments, R² is methyl, ethyl, propyl, or butyl. In some embodiments, including any of foregoing embodiments, R² is butyl. In some embodiments, including any of foregoing embodiments, the symmetric diamine is N,N′-tert-butyl ethylene diamine.

In some embodiments, including any of foregoing embodiments, the process of making the methacrylamide occurs in dichloromethane or tetrahydrofuran (THF).

In some embodiments, including any of foregoing embodiments, the process of making the methacrylamide occurs at between −20 to 20° C.

In some embodiments, including any of foregoing embodiments, the process of making the methacrylamide occurs over 10-60 minutes.

In some embodiments, including any of foregoing embodiments, the process of making the methacrylamide comprises stirring at room temperature for 10-60 minutes.

In some embodiments of the process provided herein, including any of foregoing embodiments, the molar ratio of AN to methacrylamide is 300:1, 300:2, 300:5; 300:10, 300:15; 200:1, 200:2, 200:5; 200:10, 200:15; 100:1, 100:2, 100:5; 100:10, or 100:15.

In some embodiments of the process provided herein, including any of foregoing embodiments, the molecular weight of the polymer is between 5,000 and 17,000 (Mₙ—number average).

In some embodiments of the process provided herein, including any of foregoing embodiments, step 1 is in ethylene carbonate.

In some embodiments of the process provided herein, including any of foregoing embodiments, R¹ is methyl.

In some embodiments of the process provided herein, including any of foregoing embodiments, R² is t-butyl.

In some embodiments of the process provided herein, including any of foregoing embodiments, step 1 comprises reversible deactivation (living) radical copolymerization

In some embodiments of the process provided herein, including any of foregoing embodiments, step 1 comprises organotellerium mediated radical polymerization (TERP). In some embodiments, the TERP comprises using N,N-diethyl-2-methyl-2-(methyltellanyl)propanamide as a chain transfer agent.

In some embodiments of the process provided herein, including any of foregoing embodiments, the bifunctional cross-linker is hexamethylene diisocyanate (HDI).

In some embodiments, including any of foregoing embodiments, the process comprises reducing the methyltellanyl end group using benzenethiol.

In some embodiments, including any of foregoing embodiments, the process comprises precipitating a product from methanol.

In some embodiments of the process provided herein, including any of foregoing embodiments, the chemical cross-linking occurs in a dinitrile solvent.

In some embodiments of the composition provided herein, including any of foregoing embodiments, the nitrile solvent is selected from adiponitrile (hexanedinitrile), acetonitrile, benzonitrile, butanedinitrile (succinonitrile), butyronitrile, decanenitrile, ethoxyacetonitrile, fluoroacetonitrile, glutaronitrile, hexanenitrile, heptanenitrile, heptanedinitrile, iso-butyronitrile, malononitrile (propanedinitrile or malonodinitrile), methoxyacetonitrile, nitroacetonitrile, nonanenitrile, nonanedinitrile, octanedinitrile (suberodinitrile), octanenitrile, propanenitrile, pentanenitrile, pentanedinitrile, sebaconitrile (decanedinitrile), succinonitrile, and combinations thereof.

In some embodiments of the process provided herein, including any of foregoing embodiments, step 2 comprises using hexamethylene diisocyanate (HDI).

In some embodiments of the process provided herein, including any of foregoing embodiments, step 2 comprises heating to between 80 and 100° C.

In some embodiments of the process provided herein, including any of foregoing embodiments, step 2 comprises heating to between 80-120° C. for 60-120 hours.

In some embodiments of the process provided herein, including any of foregoing embodiments, step 2 comprises heating to 100° C.

In some embodiments of the process provided herein, including any of foregoing embodiments, step 2 comprises heating to 100° C. for 104 hours.

In some embodiments of the process provided herein, including any of foregoing embodiments, step 2 comprises cooling.

In some embodiments of the process provided herein, including any of foregoing embodiments, the polymer is

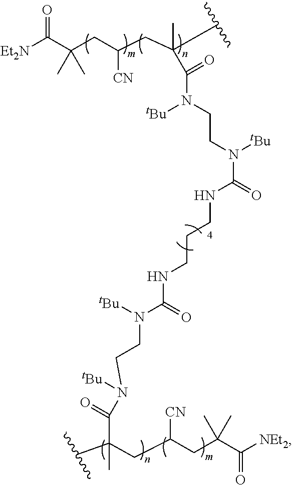

wherein subscripts n and m represent the number of repeating units in the parentheses respectively, ^{t}Bu represents t-butyl.

In some embodiments, including any of foregoing embodiments, a lithium salt is present during the process. In some embodiments, the lithium salt is selected from LiPF₆, LiBOB, LiTFSi, LiBF₄, LiClO₄, LiAsF₆, LiFSI, LiClO₄, LiI, and a combination thereof.

Provided herein is a composition made by the process of any embodiments set forth herein.

Provided herein is an electrochemical cell including a lithium metal negative electrode; a solid separator and a positive electrode; wherein the positive electrode comprises: an active material; and a catholyte; wherein the catholyte comprises a composition of any one of the embodiments set forth herein; and a lithium salt.

In some embodiments of the electrochemical cell, the solid separator is a lithium-stuffed-garnet, an LiBHI, Li₃N, a lithium-sulfide, a LiPON, a LISON, or a combination thereof.

In some embodiments of the electrochemical cell, including any of foregoing embodiments, the solid separator is a solid sulfide material.

Provided herein is an electrochemical cell including a lithium metal negative electrode, a solid separator, a positive electrode, and a bonding layer disposed between the solid separator and the positive electrode; wherein the positive electrode comprises an active material and a catholyte; and wherein the bonding layer comprises a composition of any of the embodiments set forth herein and a lithium salt.

In some embodiments of the electrochemical cell, the active material is selected from a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, LiMn₂₋ₐNiₐO₄, wherein a is from 0 to 2, and LiMPO₄, wherein M is Fe, Ni, Co, or Mn.

In some embodiments of the electrochemical cell, including any of the foregoing amendments, the active material is selected from FeF₂, NiF₂, FeOₓF₃₋₂x, FeF₃, MnF₃, CoF₃, CuF₂, alloys thereof, and combinations thereof; wherein subscript x is greater than or equal to 0 and less than or equal to 3/2.

In some embodiments of the electrochemical cell, including any of the foregoing amendments, the catholyte further comprises a carbonate solvent.

In some embodiments of the electrochemical cell, including any of the foregoing amendments, the catholyte comprises a nitrile solvent having a HOMO level of more than 7.2, 7.8, 8.0, 8.1, 8.2, 8.3, 8.5, 8.7, 8.9, 9.0, or 9.5 eV below the vacuum level.

In some embodiments of the electrochemical cell, including any of the foregoing amendments, the catholyte comprises LiBF₄, LiCF₃SO₃, LiN(CF₃SO₂)₂, or a combination thereof.

In some embodiments of the electrochemical cell, including any of the foregoing amendments, the solid separator comprises: a lithium-stuffed garnet oxide characterized by the formula LiᵤLaᵥZrₓO_{y}.zAl₂O₃, wherein
u is a rational number from 4 to 8;
v is a rational number from 2 to 4;
x is a rational number from 1 to 3;
y is a rational number from 10 to 14; and
z is a rational number from 0.05 to 1;
wherein u, v, x, y, and z are selected so that the lithium-stuffed garnet oxide is charge neutral.

In some embodiments of the electrochemical cell, including any of the foregoing amendments, the solid separator comprises: a lithium sulfide characterized by one of the following formulas:

LiₐSi_{b}Sn_{c}P_{d}SₑO_{f}, wherein 2≤a≤8,b+c=1,0.5≤d≤2.5,4≤e≤12, and 0<f≤10;

Li_{g}AsₕSnⱼSₖOₗ, wherein 2≤g≤6,0≤h≤1,0≤j≤1,2≤k≤6, and 0≤l≤10;

LiₘPₙSₚI_{q}, wherein 2≤m≤6,0≤n≤1,0≤p≤1,2≤q≤6; or
a mixture of (Li₂S):(P₂S₅) having a molar ratio from about 10:1 to about 6:4 and LiI, wherein the ratio of [(Li₂S):(P₂S₅)]:LiI is from 95:5 to 50:50;
a mixture of LiI and Al₂O₃;
Li₃N;
LPS+X, wherein X is selected from Cl, I, and Br;
vLi₂S+wP₂S₅+yLiX;
vLi₂S+wSiS₂+yLiX;
vLi₂S+wB₂S₃+yLiX;
a mixture of LiBH₄ and LiX wherein X is selected from Cl, I, and Br; or vLiBH₄+wLiX+yLiNH₂, wherein X is selected from Cl, I, and Br; and wherein coefficients v, w, and y are rational numbers from 0 to 1.

In some embodiments of the electrochemical cell, including any of the foregoing amendments, the solid separator comprises: a lithium-stuffed garnet oxide characterized by the formula LiᵤLaᵥZrₓO_{y}.zTa₂O₅, wherein
u is a rational number from 4 to 10;
v is a rational number from 2 to 4;
x is a rational number from 1 to 3;
y is a rational number from 10 to 14; and
z is a rational number from 0 to 1;
wherein u, v, x, y, and z are selected so that the lithium-stuffed garnet oxide is charge neutral.

In some embodiments of the electrochemical cell, including any of the foregoing amendments, the solid separator comprises: a lithium-stuffed garnet oxide characterized by the formula LiᵤLaᵥZrₓO_{y}.zNb₂O₅, wherein
u is a rational number from 4 to 10;
v is a rational number from 2 to 4;
x is a rational number from 1 to 3;
y is a rational number from 10 to 14; and
z is a rational number from 0 to 1;
wherein u, v, x, y, and z are selected so that the lithium-stuffed garnet oxide is charge neutral.

In some embodiments of the electrochemical cell, including any of the foregoing amendments, the solid separator comprises: a lithium-stuffed garnet oxide characterized by the formula LiᵤLaᵥZrₓO_{y}.zGa₂O₃, wherein
u is a rational number from 4 to 10;
v is a rational number from 2 to 4;
x is a rational number from 1 to 3;
y is a rational number from 10 to 14; and
z is a rational number from 0 to 1;
wherein u, v, x, y, and z are selected so that the lithium-stuffed garnet oxide is charge neutral.

In some embodiments of the electrochemical cell, including any of the foregoing amendments, the solid separator comprises: a lithium-stuffed garnet oxide characterized by the formula LiᵤLaᵥZrₓO_{y}.zTa₂O₅.bAl₂O₃, wherein
u is a rational number from 4 to 10;
v is a rational number from 2 to 4;
x is a rational number from 1 to 3;
y is a rational number from 10 to 14;
z is a rational number from 0 to 1; and
b is a rational number from 0 to 1;
wherein z+b≤1.

In some embodiments of the electrochemical cell, including any of the foregoing amendments, the solid separator comprises: a lithium-stuffed garnet oxide characterized by the formula LiᵤLaᵥZrₓO_{y}.zNb₂O₅.bAl₂O₃, wherein
u is a rational number from 4 to 10;
v is a rational number from 2 to 4;
x is a rational number from 1 to 3;
y is a rational number from 10 to 14;
z is a rational number from 0 to 1; and
b is a rational number from 0 to 1;
wherein z+b<1
wherein u, v, x, y, and z are selected so that the lithium-stuffed garnet oxide is charge neutral.

In some embodiments of the electrochemical cell, including any of the foregoing amendments, the solid separator comprises: a lithium-stuffed garnet oxide characterized by the formula LiᵤLaᵥZrₓO_{y}.zGa₂O₃.bAl₂O₃, wherein
u is a rational number from 4 to 10;
v is a rational number from 2 to 4;
x is a rational number from 1 to 3;
y is a rational number from 10 to 14;
z is a rational number from 0 to 1; and
b is a rational number from 0 to 1;
wherein z+b≤1
wherein u, v, x, y, and z are selected so that the lithium-stuffed garnet oxide is charge neutral.

In some embodiments of the electrochemical cell, including any of the foregoing amendments, the positive electrode is in direct contact with a solid electrolyte separator.

In some embodiments of the electrochemical cell, including any of the foregoing amendments, the catholyte comprises an additives selected from the group consisting of VC (vinylene carbonate), VEC (vinyl ethylene carbonate), succinic anhydride, PES (prop-1-ene, 1-3 sultone), tris(trimethylsilyl) phosphite, ethylene sulfate, PBF, TMS (1,3-propylene sulfate), propylene sulfate, trimethoxyboroxine, FEC, MMDS, TTSPi, and combinations thereof.

Provided herein is a method of using an electrochemical cell of any one of those set forth herein, including charging the electrochemical cell to a voltage greater than 4.3V.

In some embodiments, the method comprises charging the battery to a voltage greater than 4.4V, greater than 4.5V, greater than 4.6V, greater than 4.7V, greater than 4.8V, greater than 4.9V, greater than 5.0V, greater than 5.1V, greater than 5.2V, greater than 5.3V, greater than 5.4V, or greater than 5.5V.

Provided herein is a method of storing an electrochemical cell, including:
providing an electrochemical cell of any one of those set forth herein; wherein the electrochemical cell has greater than 20% state-of-charge (SOC); and
storing the battery for at least one day.

In some embodiments of the method provided herein, the storing the battery for at least one day is at a temperature greater than 20° C.

In some embodiments of the method provided herein, including any of the foregoing embodiments, the storing the battery for at least one day is at a temperature greater than 40° C.

In some embodiments of the method provided herein, including any of the foregoing embodiments, the storing the battery for at least one day is at a temperature greater than 100° C.

In some embodiments, including any of the foregoing amendments, the method further comprises charging the battery to a voltage greater than 4.3V v. Li.

### F. Examples

A new polyacrylonitrile (PAN)-based chemically cross-linked gel swollen with adiponitrile was prepared for the first time. The host polymer, PAN-copolymer, was prepared by copolymerization of acrylonitrile (AN) and a methacrylamide bearing amine functional group under organotellurium-mediated radical polymerization (TERP). Excellent control over the molecular weight and dispersity was observed. Then, the copolymers were cross-linked with a bifunctional crosslinker, hexamethylene diisocyanate (HDI), in adiponitrile to obtain the corresponding gel. The rheological study strongly supported the quantitative formation of cross-linking points and a homogeneous gel network. Alkyl dinitriles, such as adiponitrile, have wide electrochemical stability windows, which are suitable for increasing the energy density in energy-storage devices, i.e., Li-ion batteries and super capacitors. In addition, a polymer-gel electrolyte has significant advantages over liquid electrolytes due to its high safety and deformability. Therefore, the new PAN-based chemically cross-linked gel can be used for the development of new energy storage devices.

The chemically cross-linked polymer gel herein can be swollen with dinitriles. Fabricating a structurally controlled and homogeneous polymer gel are of particular interest because its homogeneity would lead to several advantages, such as a stable output and long cycle life. Therefore, the host polymer, polyacrylonitrile (PAN)-copolymer, was prepared by copolymerization of acrylonitrile (AN) and a methacrylamide bearing amine functional group under organotellurium-mediated radical polymerization (TERP). Excellent control over the molecular weight and dispersity was observed. Then, the copolymers were cross-linked with a bifunctional crosslinker in adiponitrile to obtain the corresponding gel. The rheological study strongly supported the formation of a homogeneous gel network.

Several PAN-based physically cross-linked polymer-gel electrolytes using alkyl carbonates as the electrolytes have already been reported and there is one report of chemically cross-linked PAN-based gel. However, the precursor polymer of the gel was prepared by the conventional radical polymerization so that the polymer structure was not controlled. Furthermore, carbonates were used as an electrolyte. Therefore, the chemically cross-linked polymer gel herein is the first example to fabricate structurally uniform PAN-based gels swollen with a dinitrile.

The concept for the gel design includes the following: 1) PAN was selected as the host polymer because it has an iterative dinitrile structure; 2) a chemically cross-linked gel was targeted because the chemical cross-linking point is much smaller than that of a physically cross-linked one; 3) a two-step gel fabrication method using a structurally controlled PAN polymer with functional groups and a bifunctional cross-linker was used instead of a one-step cross-linking polymerization method to increase the structural homogeneity of the gel; 4) the structurally controlled PAN was prepared by a reversible deactivation (living) radical copolymerization; while several reversible deactivation (living) radical polymerization methods were reported, TERP was used because of its high synthetic versatility; and 5) since ester functional groups have narrower ESWs than nitrile, the use of esters was avoided and amides were selected. Amides are chemically more stable than esters under reductive conditions. N,N′-dialkyl acryl or methacrylamide 1 with a secondary amine pendant group was selected to minimize the formation of a protic amide proton.

The synthesis of a structurally well controlled copolymer composed acrylonitrile (AN) and amide monomer 1 is disclosed herein. Furthermore, the copolymer to the corresponding polymer-gel with adiponitrile was fabricated.

General

All reactions with air- and moisture-sensitive compounds were carried out in a dry reaction vessel under a nitrogen atmosphere. ¹H NMR (400 MHz) and ¹³C NMR (100 MHz) spectra were measured for CDCl₃ or DMSO-d₆ solutions of the samples and are reported in ppm (δ) from the internal tetramethylsilane standard for ¹H NMR and from the solvent peak for ¹³C NMR. SEC was performed on a machine equipped with two linearly connected polystyrene mixed gel columns (Shodex LF-604) at 40° C. using RI and UV detectors. DMF containing 0.01 M LiBr was used as an eluent, and the SEC was calibrated with PMMA standards. The rheology was measured by a Piezo-Drive Rheometer Pz-Rheo NDS-1000.

Materials

Unless otherwise noted, the chemicals obtained from commercial supplies were used as received. Acrylonitrile (AN) was washed with a 5% aqueous NaOH solution, distilled over CaH₂ and deaerated by passing nitrogen gas through it. 2,2′-Azobisisobutyronitrile (ACHN) was recrystallized from methanol. All reagents and solvents used for the synthesis of TERP CTA (chain transfer agent) were deaerated by passing nitrogen gas through them.

### Synthesis of N,N′-di-tert-butyl ethylenediamine (3D) (See, e.g., as Shown in Table 1)

A glyoxal solution (5.7 mL, 40% aqueous solution) was added dropwise to a solution of tert-butylamine (10.75 mL, 100 mmol) and H₂O (10.0 mL) at 0° C. with vigorous stirring. The resulting white precipitate was stirred for 1 h at the same temperature. The precipitates were collected by filtration and recrystallized from EtOH/H₂O (1:1) to obtain N,N′-di-tert-butylethane-1,2-diimine (7.8 g, 93%). The N,N′-di-tert-butylethane-1,2-diimine (7.74 g, 46 mmol) was added to a suspension of NaBH₄ (5.20 g, 138 mmol) in methanol (100 mL) at 0° C. The reaction mixture was refluxed with stirring for 1 h, and methanol was removed to obtain a volume of approximately 20 mL under reduced pressure. Water was added (40 mL) to this mixture, and the organic compounds were extracted with dichloromethane (50 mL×3). The combined organic phase was dried over MgSO₄, and the solvent was removed to obtain the crude product, which was distilled under reduced pressure to afford 3D in a 90% yield (7.12 g) as a colorless oil.

¹H NMR (400 MHz, CDCl₃) 0.88 (brs, 2H), 1.09 (s, 18H), 2.65 (s, 4H); ¹³C NMR (100 MHz, CDCl₃) 29.1, 43.4, 50.1.

### Synthesis of 1bD (See, e.g., as Shown in Table 1)

Methacryloyl chloride (1.0 g, 10 mol) was slowly added to a solution of 3D (3.6 g, 20 mmol) in THF (80 mL) at 0° C., and the resulting mixture was stirred for 1 h at room temperature. The mixture was quenched with an aqueous, saturated NaHCO₃ solution, and the organic phase was extracted with ethyl acetate, dried over Na₂SO₄, and concentrated under reduced pressure. The crude product was purified by distillation under reduced pressure to afford 1bD in a 90% yield (2.16 g) as a colorless oil.

¹H NMR (400 MHz, CDCl₃) 0.55 (brs, 1H), 1.08 (s, 9H), 1.46 (s, 9H), 1.96 (t, J=1.6 Hz, 3H), 2.66 (t, J=7.6 Hz, 2H), 3.36 (t, J=7.6 Hz, 2H), 4.98-4.99 (m, 1H), 5.02 (quintet, J=1.6 Hz, 1H); ¹³C NMR (100 MHz, CDCl₃) 20.8, 28.8, 29.0, 44.4, 47.9, 50.2, 56.5, 113.1, 143.7, 174.3; IR (KBr) 905, 1081, 1108, 1181, 1205, 1230, 1361, 1386, 1411, 1627, 1635, 2924, 2965, 3081 cm⁻¹; HRMS (ESI-TOF) m/z: Calcd for C₁₄H₂₉N₂O (M+H)⁺: 241.2274, found: 241.2283.

### Synthesis of 5 (See, e.g., as Shown in Table 2)

Methyllithium (29.7 mL, 1.06 M solution in diethyl ether, 31.5 mmol) was slowly added to a suspension of tellurium powder (4.03 g, 33 mmol) in 50 mL of THF over 20 min at room temperature. The resulting mixture was stirred for 30 min and tellurium powder was completely disappeared. 2-Bromo-N,N-diethyl-2-methylpropanamide (5.33 mL, 30 mmol) was added to this solution at 0° C., and the resulting solution was stirred for 2 h. The solvent was removed under reduced pressure followed by distillation under reduced pressure (bp. 64° C. @0.22 Torr) to give 5 as orange oil in 75% yield (6.45 g).

¹H NMR (400 MHz, CDCl₃) 1.17 (t, J=6.8 Hz, 6H), 1.87 (s, 6H), 2.01 (s, 3H), 3.45 (brs, 4H); ¹³C NMR (100 MHz, CDCl₃) −18.6, 13.0, 26.2, 31.0, 42.5, 173.8; IR (KBr) 743, 913, 1108, 1211, 1272, 1634, 2973 cm⁻¹; ¹HRMS (FAB-MASS) m/z: Calcd for C₉H₁₉NOTe (M)⁺: 287.0524, found: 287.0529.

Typical procedure for the copolymerization of AN and 1bD to obtain 6F. The nomenclature, 1bD, refers to product 1 with reagent b from column 2 and reagent D from column 3 of Table 1.

A solution of 5 (300 μL, 1.5 mmol), AN (9.75 mL, 150 mmol), 1bD (1.9 mL, 7.5 mmol), and ACHN (181.5 mg, 0.75 mmol) in ethylene carbonate (23 mL) was stirred at 70° C. for 44 h under a nitrogen atmosphere. A small portion of the reaction mixture was withdrawn to determine the conversion of AN and 1bD. The conversion percentages of AN and 1bD were 89% and 85%, respectively, after 44 h. The NMR analysis determined M_{n(NMR)} (5150) and Ð (1.10) (Table 2, run 1). The remaining AN was removed under vacuum (0.3 mHg) at room temperature for 10 h. Benzenethiol (182 μL, 1.65 mmol) was added to the mixture, and the resulting solution was irradiated under a 6 W light emitting diode through a 20% neutral density filter at 70° C. with stirring for 5 h. DMF (20 mL) was added, and the resulting solution was added to vigorously stirred methanol (1.5 L). The product was collected by suction filtration and centrifugation, and dried under reduced pressure to obtain a white powder 6F (7.1 g) in a 94% yield. The NMR analysis determined M_{n(NMR)} (5000) and Ð (1.10).

Typical procedure for the fabrication of PAN-gel.

Copolymer 6F (400 mg, M_{n(NMR)}=15400, Ð=1.11, amine content=0.3 mmol) was dissolved in adiponitrile (4 mL) at 60° C. for 2 h to make a clear solution. Then, HDI (26 μL, 0.15 mmol, 0.5 equiv relative to the amine group in 6F) was added, and the resulting mixture was shaken for 10 min at room temperature. The reaction mixture was poured onto a glass plate, and the plate was heated at 100° C. for 78 h.

### Example 1

### Synthesis of Comonomer 1, Referring to Table 1

Acryl or methacrylamide 1 was prepared by the condensation of acryloyl or methacryloyl chloride 2 and symmetric diamine 3. At first, acryloyl chloride (2a, R¹=H) and diamine 3A (R²=Me, 2.0 equiv) were reacted in dichloromethane from 0° C. to room temperature. All 2a was consumed immediately, but, surprisingly, the desired acrylamide 1aA did not form. Instead, the selective formation of bisacrylamide 4aA was observed (Table 1, run 1). The nomenclature, 4aA, refers to product 4 with reagent a from column 2 and reagent A from column 3 of Table 1. Several conditions, including the reaction between acrylic acid and 3A in the presence of a condensation reagent, such as N,N′-dicyclohexylcarbodiimide (DCC) or 1-[bis(dimethylamino)methylene]-1H-benzotriazolium 3-oxide hexafluorophosphate (HBTU), were attempted, but the selective formation of 4 was observed in all cases. Furthermore, the use of diamines 3B and 3C with longer alkyl chains than 3A did not change the selectivity (runs 2 and 3). The results clearly indicated the secondary amine groups in 1aA, 1aB, and 1aC were more reactive than those of 3A, 3B, and 3C, respectively.

Next, N,N′-tert-butyl ethylene diamine (3D) was synthesized with expectation that the bulky tert-butyl group would retard the formation of 4. When 3D reacted with 2a, the formation of the desired 1aD was observed as the major product in a 66% yield (run 4). Furthermore, when methacryloyl chloride (2b) was used instead of 2a, the selective formation of the desired 1bD was observed over the formation of 4bD with a 99% selectivity (run 5). 1bD was successfully isolated in pure form by vacuum distillation in a 90% isolated yield.

TABLE 1
Synthesis of acrylamide co-monomer 1^{a}

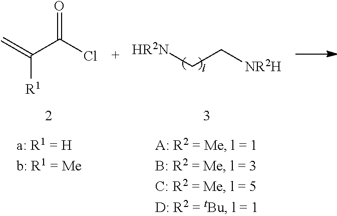

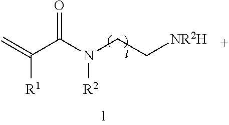

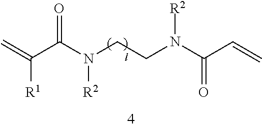

| | | | Yield (%)^{b} | |
|---|---|---|---|---|
| Run | 2 | 3 | 1 | 4 |
| 1 | a | A | >1 | 98 |
| 2 | a | B | >1 | 98 |
| 3 | a | C | >1 | 94 |
| 4 | a | D | 66 | 17 |
| 5 | b | D | 98 (90)^{e} | 1 |

^{a}Acryloyl chloride 2 was added to a solution of diamine 3 (2 equiv) in a solvent
(dichloromethane or THF) at 0° C. over 30 min, and the resulting mixture was stirred at
room temperature for 30 min.
^{b}Determined by ¹H NMR using an internal standard.
^{e}Isolate yield.

### Example 2

### Copolymerization of AN and 1bD Under TERP, Referring to Table 2

Methacrylamide 1bD was copolymerized with AN under TERP using N,N-diethyl-2-methyl-2-(methyltellanyl)propanamide 5 as the chain-transfer agent. While 5 was previously synthesized by the condensation of 2-methyl-2-(methyltellanyl)propionic acid with N,N-diethylamine, an alternative synthetic route, i.e., the reaction of N,N-diethyl-2-bromo-2-methylpropanamide and methyltellanyl lithium, was employed to obtain 5 in good yield. A mixture of 5, AN (100 equiv), 1bD (5 equiv), and 1,1′-azobis(cyclohexanecarbonitrile) (ACHN, 0.5 equiv) in ethylene carbonate (6.5 mol/L of AN) was heated at 70° C. (Table 2, run 1), and the progress of the polymerization was monitored by withdrawing a sample solution at selected time intervals.

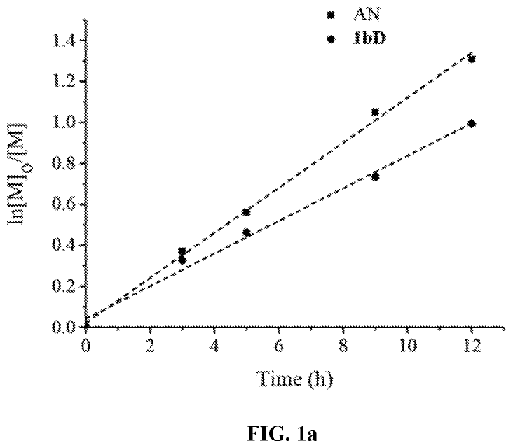

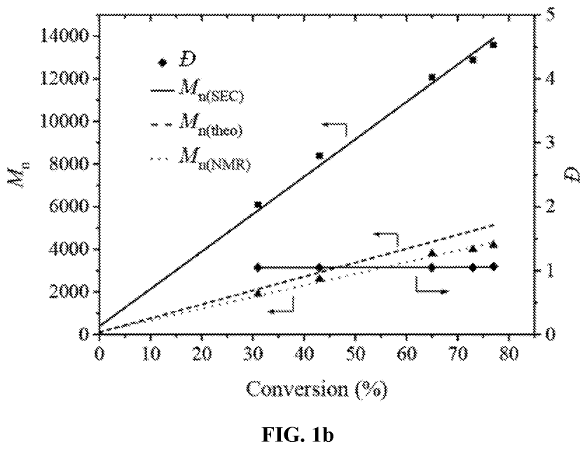

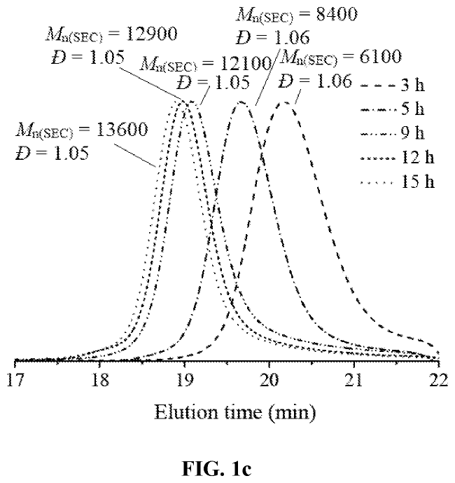

The consumption of both monomers determined by ¹H NMR followed pseudo-first-order kinetics (FIG. 1a). While the AN conversion occurred slightly faster than the 1bD conversion, the results suggest the occurrence of statistical copolymerization and homogeneous introduction of the amine functionality in the PAN chain. The number average molecular weight determined by NMR (M_{n(NMR)}) by comparing the proton resonances of the diethylamino group at the α-polymer end and those of the PAN main chain showed excellent agreement with Mₙ₍ₜₕₑₒ₎ and increased linearly with the monomer conversion (FIG. 1b). The Mₙ determined by size exclusion chromatography (SEC) calibrated against PMMA standards (M_{n(SEC)}) also increased linearly with the monomer conversion, but the M_{n(SEC)} was significantly higher than the M_{n(NMR)}. As the difference between M_{n(NMR)} and M_{n(SEC)} for the copolymer was identical to that of homo-PAN prepared independently, the methacrylamide 1bD did not affect the SEC elution. The SEC traces were unimodal throughout the polymerization period and shifted to a high molecular weight as the monomer conversion increased (FIG. 1c). In addition, the dispersity (Ð) was below 1.06. All these results are consistent with the controlled and living character of this polymerization. The conversions of AN and 1bD reached 89% and 85%, respectively, after 44 hours, and the copolymer 6E with M_{n(NMR)} of 5150 g/mol was obtained with a narrow dispersity (Ð=1.10). The methyltellanyl end group was reduced by benzenethiol, and the resulting copolymer 6F was isolated by precipitation from methanol. The amount of the free amine group was estimated to be 3.9 from the NMR analysis, which was slightly smaller than the theoretical value (4.2) calculated from the amount of 1bD and its conversion.

The same copolymerization was also examined by changing the AN/1bD. The desired copolymers with controlled Mₙ and narrow Ð were obtained after a high monomer conversion rate (runs 2 and 3). A high molecular weight copolymer 6 was also prepared by using 300 and 15 equivalents of AN and 1bD, respectively, and copolymer 6 with M_{n(NMR)}=15500 and Ð=1.11 was obtained. The amount of the free amine group in the copolymers prepared in runs 2, 3, and 4 was also estimated as 1.6, 6.0, and 11.7 equivalents, respectively, which were also slightly smaller values than the theoretical values (1.8, 6.6, and 12.6 for runs 2, 3, and 4, respectively).

TABLE 2
Copolymerization of AN with 1bD under TERP
and end-group reduction^{a}

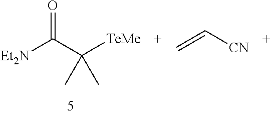

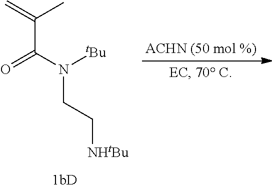

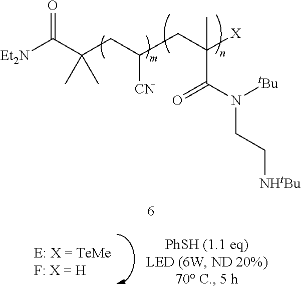

| | | | Conv. | | | | | |
|---|---|---|---|---|---|---|---|---|
| | AN/1bD | Time | (%)^{b} | | 6 | | | |
| Run | (equiv.) | (h) | AN | 1bD | Mₙ₍ₜₕₑₒ₎ | M_{n(NMR)}^{b} | M_{n(SEC)}^{c} | Ð^{c} |
| 1 | 100/5 | 44 | 89 | 85 | 5900 | 5150 | 16700 | 1.10 |
| 2 | 100/2 | 37 | 93 | 91 | 5500 | 5300 | 16000 | 1.07 |
| 3 | 100/10 | 18 | 71 | 66 | 5490 | 4550 | 14800 | 1.07 |
| 4 | 300/15 | 66 | 87 | 84 | 16800 | 15500 | 43900 | 1.11 |

^{a}Copolymerization was conducted by mixture 5, AN (100-300 equiv),
1bD (2-15 equiv), and ACHN (0.5 equiv) in ethylene carbonate at 70° C.
^{b}Determined by ¹H NMR analysis.
^{c}Determined by SEC calibrated against PMMA standards.
Mₙ₍ₜₕₑₒ₎ refers to theoretical number average molecular weight.

### Example 3

### Fabrication and Characterization of the PAN-Based Polymer Gel

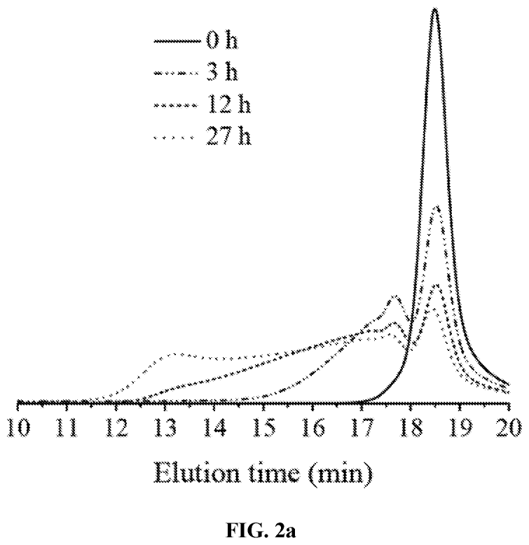

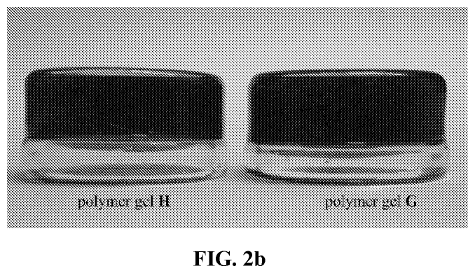

The gel was synthesized by mixing the copolymer 6F (M_{n(NMR)}=5000, Ð=1.10) prepared by Table 2, run 1 and hexamethylene diisocyanate (HDI, 0.5 equiv to the molar amount of amine groups in 6F) in adiponitrile (200 mg/mL), and the resulting mixture was transferred onto a glass plate, which was heated at 100° C. The reaction was monitored by ¹H NMR and SEC by withdrawing an aliquot at specified time intervals revealed the cross-linking reaction occurred slowly. For example, 50% of 6F was cross-linked after 3 hours, but ⅓ of 6F still remained after 27 hours (Table 3, FIG. 2a). Further monitoring could not be performed due to the increased viscosity, and the reaction was thermally quenched by cooling it to room temperature after 70 hours to obtain a gel (sample G). The other sample (H) was also prepared starting from copolymer 6F (M_{n(NMR)}=15400, Ð>=1.11) from Table 2, run 4 and HDI (0.5 equiv to the total amine group) in adiponitrile (100 mg/mL) by heating the mixture at 100° C. for 104 hours (FIG. 2b). While the Mₙ values were different between G and H, the average number of AN monomers between the two adjacent cross-linking functional groups derived from the monomer 1bD was almost the same.

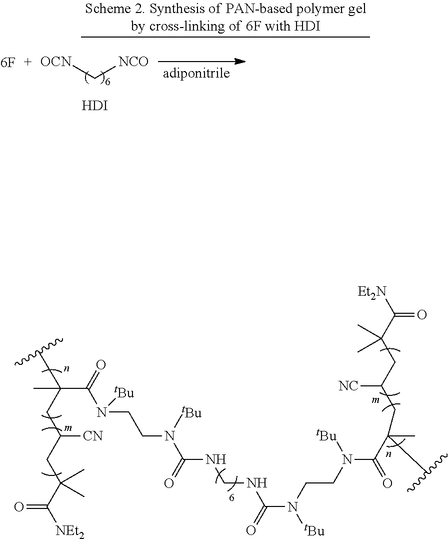

TABLE 3
Crosslinking reaction of a PAN-based copolymer^{a}

| Run | Time (h) | Conv. of 6F (%)^{b} | Conv. of HDI (%)^{c} |
|---|---|---|---|
| 1 | 3 | 50 | 38 |
| 2 | 12 | 63 | 65 |
| 3 | 27 | 75 | 84 |

^{a}HDI (0.5 equiv relative to the amino group) was added to a homogeneous solution of 6F (800 mg) in adiponitrile (4.0 mL), and the solution was poured onto a glass plate, which was placed on a hot plate at 100° C.
^{b}Estimated from SEC traces by comparing the area of 6F and other high-molecular-weight part after peak resolution.
^{c}Determined by NMR.

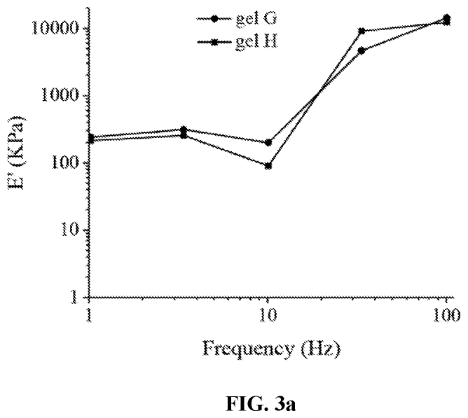

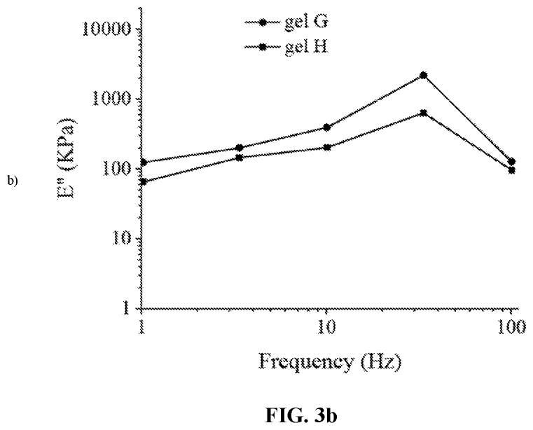

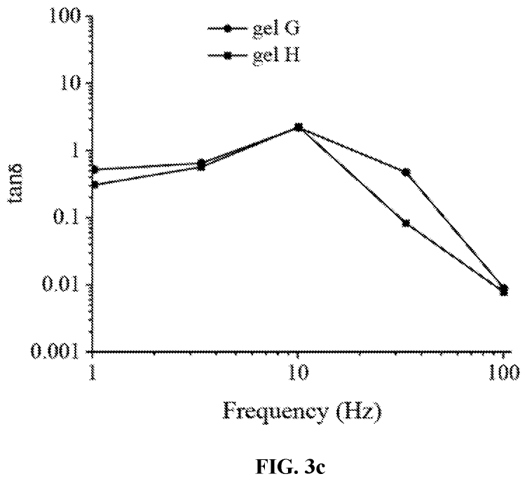

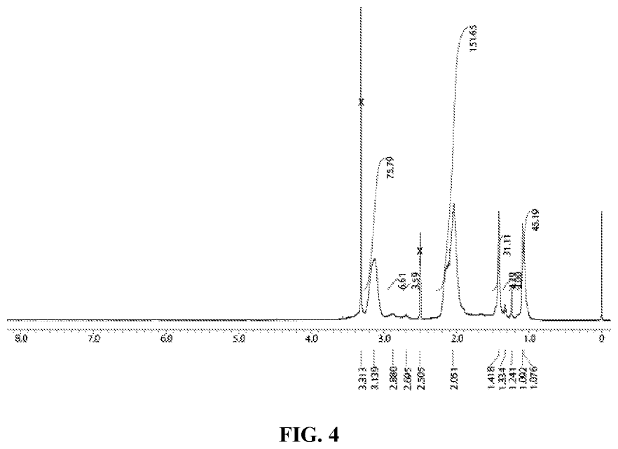

The rheological properties of the PAN-based gels G and H were examined by a linear oscillatory rheological test. The storage modulus, E′, the loss modulus, E″, and the ratio between them, tan δ (E″/E′) were measured in a frequency sweep test with an amplitude of 5 μm at 25° C. (FIGS. 3a-3c). In the case of gel, E′ is related to by the length of the network chains (i.e., the number of monomer units between the cross-linking points) if other factors are the same, and accordingly, E′ should be independent of frequency. However, E′ increased with the increase in frequency above 10 Hz. Furthermore, these gels were observed to have characteristic frequency of energy dissipation around 10 Hz, because tan δ showed the maximum and E′ showed the minimum. This may be due to the participation of entanglements as physical cross-linking points at high frequency, which increases the apparent cross-linking density. Therefore, the rheological properties below 10 Hz should be referred to for the evaluation of network structure. In this frequency range, though E′ of G was somewhat larger than that of H, they were mostly on the same order.

A larger loss modulus, E″, was obtained in the polymer gel G. This may be due to the dangling chain ends that dissipate kinetic energy. More dangling chain ends are likely to exist in the gel prepared from the copolymer with a smaller molecular weight. These rheological properties suggest the quantitative occurrence of the cross-linking reaction and the formation of a homogeneous gel.

Structurally controlled copolymers consisting of AN and methacrylamide bearing an amine functionality with different chain lengths and compositions were successfully prepared by TERP. Because AN and the co-monomer were consumed at nearly the same rate, the amine functionality was homogeneously introduced to the PAN chain. The copolymers were chemically cross-linked with HDI in adiponitrile to obtain the corresponding gel. The rheological studies of the gel suggested a nearly quantitative cross-linking reaction. All these results suggested the formation of a structurally controlled and homogeneous PAN-gel swollen with adiponitrile. Considering the advantageous properties of adiponitrile and PAN as electrolytes, i.e., high ESWs, the current PAN-gel could provide a new possibility for fabricating energy-storage devices with a high performance and safety.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

The following references may contain information that enable the practice of the invention disclosed or claimed herein.
1. Kim, D. J.; Hermann, K. R.; Prokofjevs, A.; Otley, M. T.; Pezzato, C.; Owczarek, M.; Stoddart, J. F. J. Am. Chem. Soc. 2017, 139, 6635.
2. Goodenough, J. B.; Kim, Y. Chem. Mater. 2010, 22, 587.
3. Simon, P.; Gogotsi, Y. Nat. Mater. 2008, 7, 845.
4. Armand, M.; Tarascon, J.-M. Nature 2008, 451, 652.
5. Choi, J. W.; Aurbach, D. Nat. Rev. Mater. 2016, 7, 16013.
6. Miller, J. R.; Simon, P. Science 2008, 32I, 651.
7. Stepahn, A. M.; Nahm, K. S. Polymer 2006, 47, 5952.
8. Abu-Lebdeh, Y.; Davidson, I. J. Power Sources 2009, 189, 576.
9. Ue, M.; Ida, K.; Mori, S. J. Electrochem. Soc. 1994, 141, 2989.
10. Neale, A. R.; Schütter, C.; Wilde, P.; Goodrich, P.; Hardacre, C.; Passerini, S.; Balducci, A.; Jacquemin, J. J. Chem. Eng. Data 2017, 62, 376.
11. Ghamouss, F.; Brugere, A.; Jacquemin, J. J. Phys. Chem. C 2014, 118, 14107.
12. Duncan, H.; Salem, N.; Abu-Lebdeh, Y. J. Electrochem. Soc. 2013, 160, A838.
13. Ue, M.; Takeda, M.; Takehara, M.; Mori, S. J. Electrochem. Soc. 1997, 144, 2684.
14. Brandt, A.; Isken, P.; Lex-Balducci, A.; Balducci, A. J. Power Sources 2012, 204, 213.
15. Xu, K. Chem. Rev. 2014, 114, 11503.
16. Farhat, D.; Ghamouss, F.; Maibach, J.; Edstrom, K.; Lemordan, D. ChemPhysChem. 2017, 18, 1333.
17. Yamago, S. Chem. Rev. 2009, 709, 5051.
18. Yamago, S.; Iida, K.; Yoshida, J.-i. J. Am. Chem. Soc. 2002, 724, 2874.
19. Goto, A.; Kwak, Y.; Fukuda, T.; Yamago, S.; Iida, K.; Nakajima, M.; Yoshida, J.-i. J. Am. Chem. Soc. 2003, 125, 8720.
20. Ray, B.; Kotani, M.; Yamago, S. Macromolecules 2006, 39, 5259.
21. Yamada, T.; Mishima, E.; Ueki, K.; Yamago, S. Chem. Lett. 2008, 37, 650.
22. Yusa, S.-i.; Yamago, S.; Sugahara, M.; Morikawa, S.; Yamamoto, T.; Morishima, Y. Macromolecules 2007, 40, 5907.
23. Kayahara, E.; Yamada, H.; Yamago, S. Chem. Eur. J. 2011, 77, 5272.
24. Mishima, E.; Yamago, S. Macromol. Rapid Commun. 2011, 32, 893.
25. Mishima, E.; Tamura, T.; Yamago, S. Macromolecules 2012, 45, 2989.
26. Nakamura, Y.; Nakanishi, K.; Yamago, S.; Tsujii, Y.; Takahashi, K.; Morinaga, T.; Sato, T. Macromol. Rapid Commun. 2014, 35, 642.
27. Yamago, S.; Iida, K.; Yoshida, J.-i J. Am. Chem. Soc. 2002, 124, 13666.
28. Yamago, S.; Ukai, Y.; Matsumoto, A.; Nakamura, Y. J. Am. Chem. Soc. 2009, 737, 2100.
29. Sekhon, S. S.; Arora. N.; Agnihotry, S. A. Solid State Ionics 2000, 736-737, 2101.
30. Dissanayake, M. A. K. L.; Bandara, L. R. A. K.; Bokalawala, R. S. P.; Jayathilaka, P. A. R. D.; Ileperuma, O. A.; Somasundaram, S. Mater. Res. Bull. 2002, 37, 867.
31. Nicotera, I.; Coppola, L.; Oliviero, C.; Russo, A.; Ranieri, G. A. Solid State Ionics 2004, 767, 213.
32. Luo, D.; Li, Y.; Yang, M. Mater. Chem. Phys. 2011, 125, 231.
33. Encyclopedia of Radicals in Chemistry, Biology and Materials; Chatgilialoglu, C., Studer, A., Eds.; Wiley: Chichester, UK, 2012.
34. Polymer Science: A Comprehensive Reference; Matyjaszewski, K., Möller, M., Eds.; Elsevier B. V: Amsterdam, 2012; Vol. 3.
35. Moad, G.; Rizzardo, Z.; Thang, S. H. Polymer 2008, 49, 1079.
36. Hurtgen, M.; Detrembleur, C.; Jerome, C.; Debuigne, A. Polym. Rev. 2011, 57, 188.
37. Matyjaszewski, K.; Xia, J. Chem. Rev. 2001, 101, 2921.
38. Ouchi, M.; Terashima, T.; Sawamoto, M. Chem. Rev. 2009, 109, 4963.
39. Fan, W.; Nakamura, Y.; Yamago, S. Chem. Eur. J. 2016, 22, 17006.
40. Yamago, S.; Matsumoto, A. J. Org. Chem. 2008, 73, 7300.
41. Treloar, L. R. G. The Physics of Rubber Elasticity, 3rd Ed.; Clarendon Press: Oxford, 1975.
42. Haaf, M.; Schmedake, T. A.; Paradise, B. J.; West, R. Can. J. Chem. 2000, 78, 1526.

What is claimed is:

1. A composition comprising a chemically-cross linked polymer comprising at least one cyano (—CN) functional group and a solvent selected from the group consisting of a nitrile, a dinitrile, or a combination thereof.

2. The composition of claim 1, further comprising a lithium salt.

3. The composition of claim 1 or 2, wherein the composition has a G′/G″ modulus ratio greater than or equal to 1.

4. The composition of claim 3, wherein the composition has a G′/G″ modulus ratio greater than 1.

5. The composition of claim 3, wherein the composition has a G′/G″ modulus ratio equal to 1.

6. The composition of any one of claims 1-5, comprising cross-linker positions arranged in a model network.

7. The composition of any one of claims 1-6, wherein the composition does not comprise any ester groups.

8. The composition of any one of claims 1-7, wherein the composition does not comprise any ether groups.

9. The composition of any one of claims 1-7, wherein the composition does not comprise any ester or ether groups.

10. The composition of any one of claims 1-7, wherein the composition comprises amide containing linking groups.

11. The composition of any one of claims 1-10, wherein the composition is stable at 4V v. Li.

12. The composition of any one of claims 1-11, wherein the composition is stable at 4V or greater v. Li.

13. The composition of any one of claims 1-12, wherein the composition is stable at 4V, 4.1V, 4.2V, 4.3V, 4.4V, 4.5V, 4.6V, 4.7V, 4.8V, 4.9V, 5.0V, 5.1V, or 5.2V v. Li.

14. The composition of any one of claims 1-13, wherein the composition is stable at 5.2V or greater v. Li.

15. The composition of any one of claims 1-14, wherein the polymer is a poly(acrylonitrile) (PAN) or derivative thereof.

16. The composition of claim 15, wherein the PAN comprises amide functional groups.

17. The composition of any one of claims 15-16, wherein the PAN comprises urea functional groups.

18. The composition of any one of claims 15-17, wherein the PAN does not comprise ester functional groups.

19. The composition of any one of claims 1-19, wherein the solvent is selected from adiponitrile, acetonitrile, benzonitrile, butanedinitrile, butyronitrile, decanenitrile, ethoxyacetonitrile, fluoroacetonitrile, glutaronitrile, hexanenitrile, heptanenitrile, heptanedinitrile, iso-butyronitrile, malononitrile, methoxyacetonitrile, nitroacetonitrile, nonanenitrile, nonanedinitrile, octanedinitrile, octanenitrile, propanenitrile, pentanenitrile, pentanedinitrile, sebaconitrile, succinonitrile, and combinations thereof.

20. The composition of any one of claims 1-19, wherein the solvent is adiponitrile.

21. The composition of any one of claims 1-20, wherein the polymer is swollen with the solvent.

22. The composition of any one of claims 1-21, wherein the polymer is swollen with adiponitrile.

23. The composition of any one of claims 1-22, wherein the polymer is of any one of the following formulas: 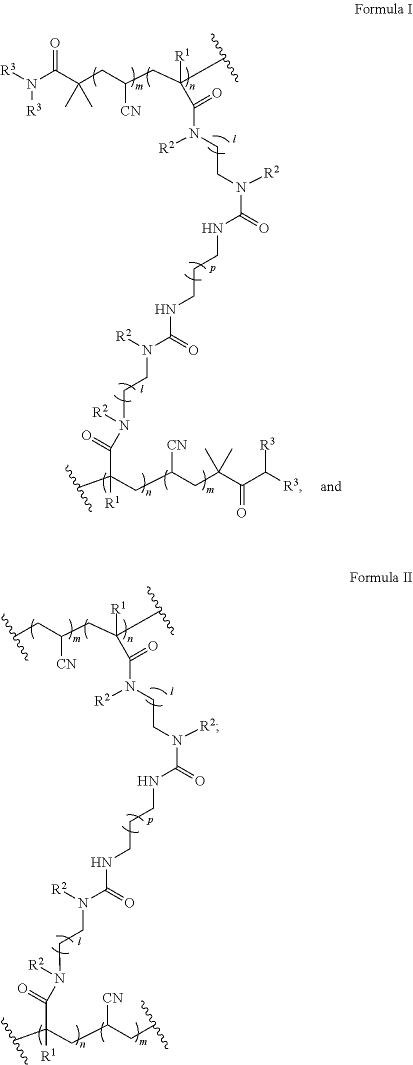
wherein:
R¹ is selected from H and alkyl;
R² is selected from methyl, ethyl, propyl, butyl, pentyl, hexyl, heptyl, octyl, nonyl, and decyl;
R³ is independently selected from methyl, ethyl, propyl, butyl, pentyl, hexyl, heptyl, octyl, nonyl, and decyl;
subscript l is an integer selected from 1 to 10;
subscript p is an integer selected from 1 to 10; and
subscripts n and m represent the numbers of repeating units in the parentheses respectively and are independently an integer from 1 to 10,000 inclusive.

24. The composition of claim 23, wherein
R¹ is H or methyl;
R² is selected from methyl and t-butyl;
R³ is ethyl;
subscript l is selected from 1, 3, and 5; and
subscript p is 4.

25. The composition of claim 23 or 24, wherein the polymer is of the following formula: 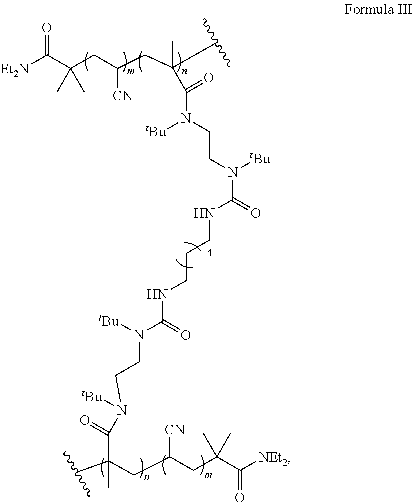
wherein ^{t}Bu represents t-butyl.

26. The composition of any one of claims 23-24, wherein the polymer is made by polymerizing a monomer selected from 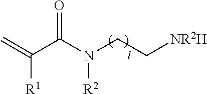
and an acrylonitrile monomer; wherein R¹ is selected from H and alkyl; R² is selected from methyl, ethyl, propyl, butyl, pentyl, hexyl, heptyl, octyl, nonyl, and decyl; and subscript 1 is an integer from 1 to 10.

27. The composition of any one of claims 23-26, wherein R¹ is methyl.

28. The composition of any one of claims 23-26, wherein R² is selected from methyl, ethyl, propyl, and butyl.

29. The composition of claim 28, wherein R² is butyl.

30. The composition of claim 28, wherein R² is t-butyl.

31. The composition of any one of claims 23-30, wherein subscript is 1, 2, 3, 4, or 5.

32. The composition of any one of claims 1-31, wherein the molecular weight of the polymer is between 5,000 and 17,000 g/mol (Mₙ—number average).

33. The composition of any one of claims 1-32, wherein the dispersity of the polymer is between 0.5 and 1.2.

34. The composition of any one of claims 1-33, wherein the dispersity of the polymer is 1.11.

35. The composition of any one of claims 1-34, wherein the storage modulus of the polymer is between 10⁴ and 10⁶ Pa.

36. The composition of any one of claims 1-34, wherein the storage modulus of the polymer is between 10^{5.2} and 10^{5.7} Pa.

37. The composition of any one of claims 1-36, wherein the composition comprises a solvent or mixture of solvents, wherein the solvent or mixture of solvents has a boiling point greater than 80° C.

38. The composition of any one of claims 1-37, wherein the composition comprises a solvent having a HOMO level of more than 7.2 eV below the vacuum level and up to 11.5 eV below the vacuum level.

39. The composition of any one of claims 1-38, wherein the composition comprises a polar and aprotic solvent.

40. The composition of any one of claims 1-39, wherein the composition comprises a member selected from the group consisting of fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane (i.e., 1,1,2,2-tetrafluoro-3-(1,1,2,2-tetrafluoroethoxy)propane (F-EPE)), fluorinated cyclic carbonate (F-AEC), tris(trimethylsilyl)phosphite (TTSPi), and combinations thereof.

41. The composition of any one of claims 1-40, wherein the composition comprises a member selected from the group consisting of methylene methanedisulfonate (MMDS), methyl pivalate, 1,2 dioxane, sulfolane, and combinations thereof.

42. The composition of any one of claims 1-41, wherein the composition comprises an organic sulfur-including solvent selected from ethyl methyl sulfone, dimethyl sulfone, sulfolane, allyl methyl sulfone, butadiene sulfone, butyl sulfone, methyl methanesulfonate, dimethyl sulfite, and combinations thereof.

43. The composition of any one of claims 1-42, wherein the composition comprises a lithium salt selected from LiPF₆, LiBOB, LiTFSi, LiBF₄, LiClO₄, LiAsF₆, LiFSI, LiI, and a combination thereof.

44. The composition of any one of claims 1-43, wherein the composition does not comprise

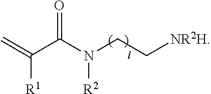

45. The composition of any one of claims 1-44, wherein the composition does not comprise

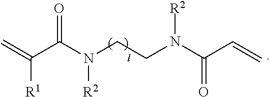

46. A process for making a composition, comprising:
step 1: copolymerizing an acrylonitrile (AN) monomer and a second monomer to form a polymer, wherein the second monomer comprises amide functional groups; and
step 2: chemically cross-linking the polymer using a bifunctional cross-linker to form a cross-linked polymer.

47. The process of claim 46, wherein the second monomer is a methacrylamide monomer.

48. The process of claim 46, wherein the second monomer comprises secondary amine functional groups.

49. The process of any one of claims 47-48, wherein the methacrylamide monomer does not comprise primary amine functional groups.

50. The process of any one of claims 47-49, wherein the methacrylamide monomer does not comprise quaternary amine functional groups.

51. The process of any one of claims 47-50, wherein the methacrylamide monomer is a N,N′-dialkyl acrylamide monomer.

52. The process of any one of claims 47-51, wherein the methacrylamide monomer is 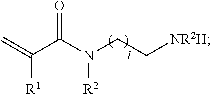
wherein R¹ is selected from H and alkyl; R² is selected from methyl, ethyl, propyl, butyl, pentyl, hexyl, heptyl, octyl, nonyl, and decyl; and subscript l is an integer from 1 to 10.

53. The process of any one of claims 47-52, wherein the methacrylamide monomer is 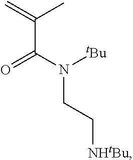
wherein ^{t}Bu represents t-butyl.

54. The process of any one of claims 46-53, wherein the AN monomer is

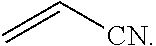

55. The process of any one of claims 46-54, wherein the methacrylamide monomer is made by condensing an acryloyl and a symmetric diamine.

56. The process of claim 55, wherein the chemically cross-linked polymer is made by reversible deactivation (living) radical copolymerization.

57. The process of claim 55, wherein the methacrylamide monomer is made using condensation reagent.

58. The process of claim 57, wherein the condensation reagent is selected from N,N′-dicyclohexylcarbodiimide (DCC) or 1-[bis(dimethylamino)methylene]-1H-benzotriazolium 3-oxide hexafluorophosphate (HBTU).

59. The process of any one of claims 55-58, wherein the acryloyl is 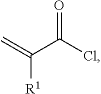
wherein R¹ is selected from H and alkyl.

60. The process of claim 59, wherein R¹ is methyl.

61. The process of any one of claims 54-60, wherein the symmetric diamine is 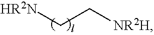
wherein R is selected from methyl, ethyl, propyl, butyl, pentyl, hexyl, heptyl, octyl, nonyl, and decyl; and subscript 1 is an integer from 1 to 10.

62. The process of claim 61, wherein R² is methyl, ethyl, propyl, or butyl.

63. The process of claim 61 or 62, wherein R² is butyl.

64. The process of any one of claims 54-62, wherein the symmetric diamine is N,N′-tert-butyl ethylene diamine.

65. The process of any one of claims 55-64, wherein the process of making the methacrylamide monomer occurs in dichloromethane or tetrahydrofuran (THF).

66. The process of any one of claims 55-65, wherein the process of making the methacrylamide monomer occurs at between −20 to 20° C.

67. The process of any one of claims 55-66, wherein the process of making the methacrylamide monomer occurs over 10-60 min.

68. The process of any one of claims 55-67, wherein the process of making the methacrylamide monomer comprises stirring at room temperature for 10-60 min.

69. The process of any one of claims 46-68, wherein the molar ratio of AN to methacrylamide monomer is 300:1, 300:2, 300:5; 300:10, 300:15; 200:1, 200:2, 200:5; 200:10, 200:15; 100:1, 100:2, 100:5; 100:10, or 100:15.

70. The process of any one of claims 46-69, wherein the molecular weight of the polymer is between 5,000 and 17,000 g/mol (Mₙ—number average).

71. The process of any one of claims 46-70, wherein step 1 is in ethylene carbonate.

72. The process of any one of claims 46-71, wherein R¹ is methyl.

73. The process of any one of claims 46-72, wherein R² is t-butyl.

74. The process of any one of claims 46-73, wherein step 1 comprises reversible deactivation (living) radical copolymerization.

75. The process of any one of claims 46-74, wherein step 1 comprises organotellerium mediated radical polymerization (TERP).

76. The process of claim 75, wherein the TERP comprises using N,N diethyl-2-methyl-2-(methyltellanyl)propanamide as a chain transfer agent.

77. The process of any one of claims 46-76, wherein the bifunctional cross-linker is hexamethylene diisocyanate.

78. The process of any one of claims 76-77, comprising reducing the methyltellanyl end group using benzenethiol.

79. The process of any one of claims 46-78, comprising precipitating a product from methanol.

80. The process of any one of claims 46-79, wherein the chemical cross-linking occurs in a dinitrile solvent.

81. The process of claim 80, wherein the solvent is selected from adiponitrile, acetonitrile, benzonitrile, butanedinitrile, butyronitrile, decanenitrile, ethoxyacetonitrile, fluoroacetonitrile, glutaronitrile, hexanenitrile, heptanenitrile, heptanedinitrile, iso-butyronitrile, malononitrile, methoxyacetonitrile, nitroacetonitrile, nonanenitrile, nonanedinitrile, octanedinitrile, octanenitrile, propanenitrile, pentanenitrile, pentanedinitrile, sebaconitrile, succinonitrile, and combinations thereof.

82. The process of any one of claims 46-81, wherein the solvent is adiponitrile.

83. The process of any one of claims 46-82, wherein step 2 comprises using hexamethylene diisocyanate (HDI).

84. The process of any one of claims 46-83, wherein step 2 comprises heating to between 80 and 100° C.

85. The process of any one of claims 46-84, wherein step 2 comprises heating to between 80-120° C. for 60-120 hours.

86. The process of any one of claims 46-85, wherein step 2 comprises heating to 100° C.

87. The process of any one of claims 46-86, wherein step 2 comprises heating to 100° C. for 104 hours.

88. The process of any one of claims 46-87, wherein step 2 comprises cooling.

89. The process of any one of claims 46-88, wherein the polymer is 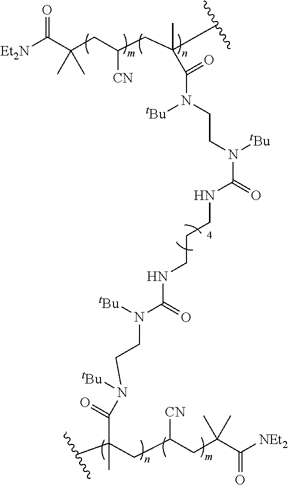
wherein subscripts n and m represent the number of repeating units in the parentheses respectively, wherein ^{t}Bu represents t-butyl.

90. The process of any one of claims 46-89, wherein a lithium salt is present during the process.

91. The process of claim 90, wherein the lithium salt is selected from LiPF₆, LiBOB, LiTFSi, LiBF₄, LiClO₄, LiAsF₆, LiFSI, LiI, and a combination thereof.

92. A composition made by the process of any one of claims 46-91.

93. An electrochemical cell comprising:
a lithium metal negative electrode,
a solid separator, and
a positive electrode,
wherein the positive electrode comprises:
an active material, and
a catholyte,
wherein the catholyte comprises a composition of any one of claims 1-45 and 92; and a lithium salt.

94. The electrochemical cell of claim 93, wherein the solid separator is a lithium-stuffed-garnet, an LiBHI, Li₃N, a lithium-sulfide, a LiPON, a LISON, or a combination thereof.

95. The electrochemical cell of claim 93 or 94, wherein the solid separator is a solid sulfide material.

96. An electrochemical cell comprising:
a lithium metal negative electrode,
a solid separator,
a positive electrode, and
a bonding layer disposed between the solid separator and the positive electrode;
wherein the positive electrode comprises:
an active material and a catholyte; and
wherein the bonding layer comprises a composition of any one of claims 1-45 or 92; and a lithium salt.

97. The electrochemical cell of claim 96, wherein the bonding layer is between and in direct contact with the solid separator and the positive electrode.

98. The electrochemical cell of any one of claims 96-97, wherein the active material is selected from a nickel manganese cobalt oxide (NMC), a nickel cobalt aluminum oxide (NCA), Li(NiCoAl)O₂, a lithium cobalt oxide (LCO), a lithium manganese cobalt oxide (LMCO), a lithium nickel manganese cobalt oxide (LMNCO), a lithium nickel manganese oxide (LNMO), Li(NiCoMn)O₂, LiMn₂O₄, LiCoO₂, LiMn₂₋ₐNiₐO₄, wherein a is from 0 to 2, and LiMPO₄, wherein M is Fe, Ni, Co, or Mn.

99. The electrochemical cell of any one of claims 96-98, wherein the active material is selected from FeF₂, NiF₂, FeOₓF₃₋₂ₓ, FeF₃, MnF₃, CoF₃, CuF₂, alloys thereof, and combinations thereof, wherein 0≤x≤3/2.

100. The electrochemical cell of any one of claims 96-99, wherein the catholyte further comprises a carbonate solvent.

101. The electrochemical cell of any one of claims 96-100, wherein the catholyte comprises a nitrile solvent having a HOMO level of more than 7.2, 7.8, 8.0, 8.1, 8.2, 8.3, 8.5, 8.7, 8.9, 9.0, or 9.5 eV below the vacuum level.

102. The electrochemical cell of any one of claims 96-101, wherein the catholyte comprises LiBF₄, LiCF₃SO₃, LiN(CF₃SO₂)₂, or a combination thereof.

103. The electrochemical cell of any one of claims 96-102, wherein the solid separator comprises:
a lithium-stuffed garnet oxide characterized by the formula LiᵤLaᵥZrₓO_{y}.zAl₂O₃, wherein
4≤u≤8;
2≤v≤4;
1≤x≤3;
10≤y≤14; and
0.05≤z≤1;
wherein u, v, x, y, and z are selected so that the lithium-stuffed garnet oxide is charge neutral.

104. The electrochemical cell of any one of claims 96-102, wherein the solid separator comprises:
a lithium sulfide characterized by one of the following Formulas:
LiₐSi_{b}Sn_{c}P_{d}SₑO_{f}, wherein 2≤a≤8,b+c=1,0.5≤d≤2.5,4≤e≤12, and 0<f≤10;
Li_{g}AsₕSnⱼSₖOₗ, wherein 2≤g≤6,0≤h≤1,0≤j≤1,2≤k≤6, and 0≤l≤10;
LiₘPₙSₚI_{q}, wherein 2≤m≤6,0≤n≤1,0≤p≤1,2≤q≤6; or
a mixture of (Li₂S):(P₂S₅) having a molar ratio from about 10:1 to about 6:4 and LiI, wherein the ratio of [(Li₂S):(P₂S₅)]:LiI is from 95:5 to 50:50;
a mixture of LiI and Al₂O₃;
Li₃N;
LPS+X, wherein X is selected from Cl, I, and Br;
vLi₂S+wP₂S₅+yLiX;
vLi₂S+wSiS₂+yLiX;
vLi₂S+wB₂S₃+yLiX;
a mixture of LiBH₄ and LiX wherein X is selected from Cl, I, and Br; or
vLiBH₄+wLiX+yLiNH₂, wherein X is selected from Cl, I, and Br; and
wherein coefficients v, w, and y are each, independently in each instance, rational numbers from 0 to 1.

105. The electrochemical cell of any one of claims 96-102, wherein the solid separator comprises:
a lithium-stuffed garnet oxide characterized by the formula LiᵤLaᵥZrₓO_{y}.zTa₂O₅,
wherein
4≤u≤10;
2≤v≤4;
1≤x≤3;
10≤y≤14; and
0.0≤z≤1;
wherein u, v, x, y, and z are selected so that the lithium-stuffed garnet oxide is charge neutral.

106. The electrochemical cell of any one of claims 96-102, wherein the solid separator comprises:
a lithium-stuffed garnet oxide characterized by the formula LiᵤLaᵥZrₓO_{y}.zNb₂O₅, wherein
u is a rational number from 4 to 10;
2≤v≤4;
1≤x≤3;
10≤y≤14; and
0≤z≤1;
wherein u, v, x, y, and z are selected so that the lithium-stuffed garnet oxide is charge neutral.

107. The electrochemical cell of any one of claims 96-102, wherein the solid separator comprises:
a lithium-stuffed garnet oxide characterized by the formula LiᵤLaᵥZrₓO_{y}.zGa₂O₃, wherein
u is a rational number from 4 to 10;
2≤v≤4;
1≤x≤3;
10≤y≤14; and
0≤z≤1;
wherein u, v, x, y, and z are selected so that the lithium-stuffed garnet oxide is charge neutral.

108. The electrochemical cell of any one of claims 96-102, wherein the solid separator comprises:
a lithium-stuffed garnet oxide characterized by the formula
LiᵤLaᵥZrₓO_{y}.zTa₂O₅.bAl₂O₃, wherein
u is a rational number from 4 to 10;
2≤v≤4;
1≤x≤3;
10≤y≤14; and
0≤z≤1; and
b is a rational number from 0 to 1;
wherein z+b≤1

109. The electrochemical cell of any one of claims 96-102, wherein the solid separator comprises:
a lithium-stuffed garnet oxide characterized by the formula
LiᵤLaᵥZrₓO_{y}.zNb₂O₅.bAl₂O₃, wherein
u is a rational number from 4 to 10;
2≤v≤4;
1≤x≤3;
10≤y≤14; and
0≤z≤1; and
b is a rational number from 0 to 1;
wherein z+b≤1
wherein u, v, x, y, and z are selected so that the lithium-stuffed garnet oxide is charge neutral.

110. The electrochemical cell of any one of claims 96-102, wherein the solid separator comprises:
a lithium-stuffed garnet oxide characterized by the formula LiᵤLaᵥZrₓO_{y}.z Ga₂O₃.bAl₂O₃, wherein
u is a rational number from 4 to 10;
2≤v≤4;
1≤x≤3;
10≤y≤14; and
0≤z≤1; and
b is a rational number from 0 to 1;
wherein z+b≤1
wherein u, v, x, y, and z are selected so that the lithium-stuffed garnet oxide is charge neutral.

111. The electrochemical cell of any one of claims 96-110, wherein the positive electrode is in direct contact with a solid electrolyte separator.

112. The electrochemical cell of any one of claims 96-110, wherein the catholyte comprises an additives selected from the group consisting of VC (vinylene carbonate), VEC (vinyl ethylene carbonate), succinic anhydride, PES (prop-1-ene, 1-3 sultone), tris(trimethylsilyl) phosphite, ethylene sulfate, PBF, TMS (1,3-propylene sulfate), propylene sulfate, trimethoxyboroxine, FEC, MMDS, TTSPi, and combinations thereof.

113. A method of using an electrochemical cell of any one of claims 96-112, comprising charging the electrochemical cell to a voltage greater than 4.3 V.

114. The method of claim 113, comprising charging the battery to a voltage greater than 4.4V, greater than 4.5V, greater than 4.6V, greater than 4.7V, greater than 4.8V, greater than 4.9V, greater than 5.0V, greater than 5.1V, greater than 5.2V, greater than 5.3V, greater than 5.4V, or greater than 5.5V.

115. A method of storing an electrochemical cell, comprising:
providing an electrochemical cell of any one of claims 96-114; wherein the an electrochemical cell has greater than 20% state-of-charge (SOC); and
storing the battery for at least one day.

116. The method of claim 115, wherein the storing the battery for at least one day is at a temperature greater than 20° C.

117. The method of claim 116, wherein the storing the battery for at least one day is at a temperature greater than 40° C.

118. The method of claim 117, wherein the storing the battery for at least one day is at a temperature greater than 100° C.

119. The method of any one of claims 115-118, further comprising charging the battery to a voltage greater than 4.3V v. Li.
